(19) United States
(12) Patent Application Publication
(10) Pub. No.: US 2008/0170265 A1
(43) Pub. Date: Jul. 17, 2008

(54) IMAGE PROCESSING DEVICE, IMAGE FORMING APPARATUS, IMAGE FORMING SYSTEM, IMAGE PROCESSING METHOD AND COMPUTER READABLE MEDIUM

(75) Inventor: Yoichi MATSUDA, Saitama-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 11/874,279

(22) Filed: Oct. 18, 2007

(30) Foreign Application Priority Data
Jan. 17, 2007 (JP) 2007-007668

(51) Int. Cl. G06K 15/00

(52) U.S. Cl. 358/3.1

(57) ABSTRACT

An image processing device includes: an image acquisition section that acquires image information; and an image processing section that obtains a plurality pieces of density information on background of the image information for different detection process units in detection process of background density of the image information, and eliminates the background from the image information based on the plurality of pieces of density information for the detection process units.

### CROSS-REFERENCE TO RELATED APPLICATION

This application is based on and claims priority under 35 USC §119 from Japanese Patent Application No. 2007-7668 filed Jan. 17, 2007.

### BACKGROUND

(i) Technical Field

The present invention relates to an image processing device, an image forming apparatus, an image forming system, an image processing method, and a computer readable medium.

(ii) Related Art

As is well-known, an image forming apparatus such as a copier reads an original such as a document or drawing and performs image forming process based on the read image data.

Originals such as drawings frequently have unevenness on their backgrounds as observed on diazo-printed originals. In the case of a diazo-printed original obtained by diazo-printing an original having no background, e.g., an original having characters and lines drawn on white background, there is “blue background” which is unnecessary information in practice.

Under such a circumstance, for example, when an image forming apparatus as described above performs a copying process on such a diazo-printed original, background eliminating process is performed on image data obtained by reading the diazo-printed original.

The image forming apparatus also performs the background eliminating process on image data obtained by reading an original whose background density has become uneven throughout the drawing as a result of deterioration attributable to sunburn and aging or an original obtained by combining a plurality of drawings (what is called a combined original) when performing, for example, a coping process on such an original.

### SUMMARY

According to an aspect of the invention, there is provided an image processing device comprising:

an image acquisition section that acquires image information; and

an image processing section that obtains a plurality pieces of density information on background of the image information for different detection process units in detection process of background density of the image information, and eliminates the background from the image information based on the plurality of pieces of density information for the detection process units.

### BRIEF DESCRIPTION OF THE DRAWINGS

Embodiments of the present invention will be described in detail based on the following figures, wherein:

FIG. 1 is a block diagram showing a functional configuration of an image processing device according to Embodiment 1 of the invention;

FIG. 2 is a configuration diagram showing a configuration of a data input unit according to Embodiment 1;

FIGS. 3A, 3B, and 3C are illustrations for explaining how to specify parameters in background elimination process according to Embodiment 1;

FIG. 4 is an illustration for explaining a normal original according to Embodiment 1;

FIG. 5 is an illustration for explaining a first detection process unit according to Embodiment 1;

FIG. 6 is an illustration for explaining a second detection process unit according to Embodiment 1;

FIGS. 7A and 7B are graphs for explaining how to calculate a background level according to Embodiment 1;

FIG. 8 is an illustration for explaining adjustment of large area background level performed by a background density adjusting part according to Embodiment 1;

FIG. 9 is an illustration for explaining adjustment of large area background level performed by the background density adjusting part according to Embodiment 1;

FIG. 10 is a configuration diagram showing a configuration of an image forming system including an image forming apparatus having the image processing device according to Embodiment 1;

FIG. 11 is a flow chart showing processing steps of image processing performed by the image processing device according to Embodiment 1;

FIG. 12 is a flow chart showing processing steps of a background detecting process performed by an image processing unit according to Embodiment 1;

FIGS. 13A, 13B, and 13C are illustrations for explaining the steps and result of the background detecting process performed by the image processing unit according to Embodiment 1;

FIG. 14 is a diagram showing the result of a detection process performed by a small area background level detecting part according to Embodiment 1;

FIG. 15 is a diagram showing the result of a detection process performed by a large area background level detecting part according to Embodiment 1;

FIG. 16 is a flow chart showing processing steps of a background elimination process performed by the image processing unit according to Embodiment 1;

FIG. 17 is a flow chart showing processing steps of a process of adjusting large area background level information performed by a background level processing part according to Embodiment 1;

FIG. 18 is a graph for explaining a specific example of a process of adjusting background density reference information performed by a background density determination part according to Embodiment 1;

FIG. 19 is a graph for explaining a specific example of the process of adjusting background density reference information performed by the background density determination part according to Embodiment 1;

FIG. 20 is a graph for explaining background density reference information which has been finally calculated by the background density determination part according to Embodiment 1;

FIG. 21 is an illustration showing an example of an output image which has been subjected to the background elimination process on the normal original shown in FIG. 14;

FIG. 22 is an illustration for explaining a combined original according to Embodiment 2 of the invention;

FIGS. 23A to 23E are illustrations for explaining how so specify parameters in background elimination process according to Embodiment 2;

FIG. 24 is a flow chart showing processing steps of a background detecting process performed by an image processing unit according to Embodiment 2;

FIG. 25 is a flow chart showing processing steps of a background elimination process performed by the image processing unit according to Embodiment 2; and

FIG. 26 is an illustration showing an example of an output image obtained by performing the background elimination process on the combined original shown in FIG. 22.

### DETAILED DESCRIPTION

Exemplary embodiments of the invention will now be described in detail with reference to the drawings. Throughout the drawings presented for explaining the embodiments, like elements are indicated by like reference numerals to avoid repeated description.

### Embodiment 1

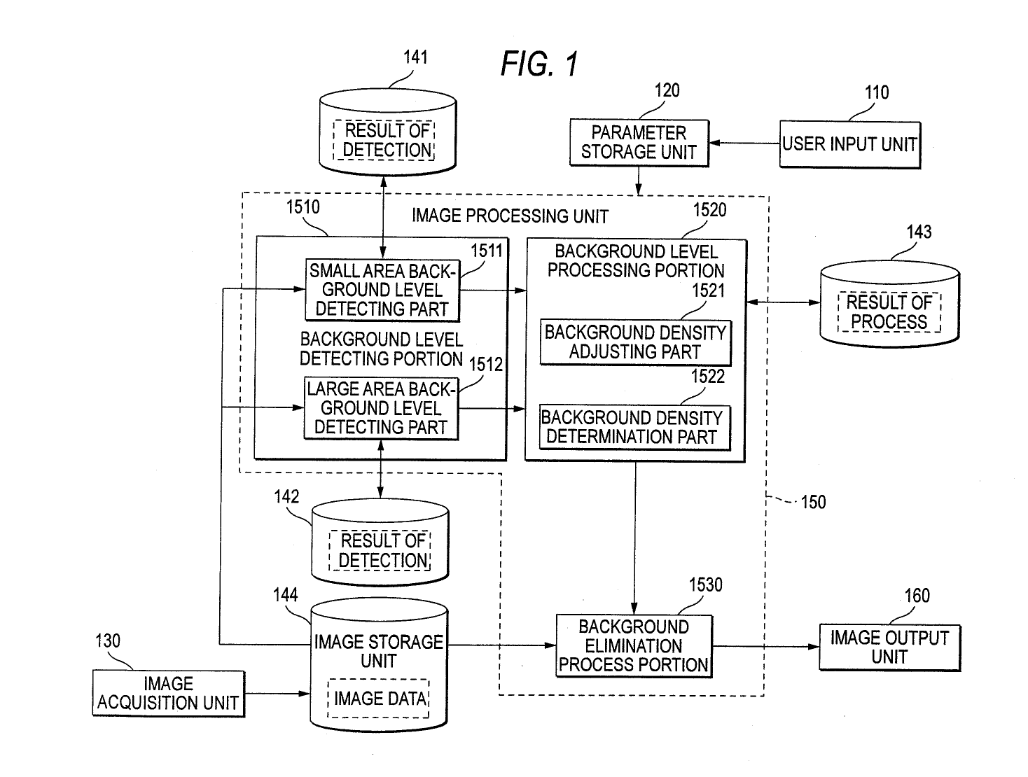

FIG. 1 shows a functional configuration of an image processing device according to exemplary Embodiment 1 of the invention.

As shown in FIG. 1, an image processing device 100 includes a user input unit 110, a parameter storage unit 120, an image acquisition unit 130, a plurality of storage units 141, 142, and 143, an image processing unit 150, and an image output unit 160.

The user input unit 110 is used for giving an instruction for a process on an original such as copying process or scanning process and for inputting parameters in background eliminating process to be performed on image information.

Specifically, the user input unit 110 includes an operation panel portion 1100, and the operation panel portion 1100 includes a display part 1110, a moving key part 1120, and an input key part 1130.

The display part 1110 includes a liquid crystal display, and displays contents according to display information. The moving key part 1120 includes moving keys for moving a cursor up and down and to the left and right to select items such as alternatives, displayed on the display part 1110 and to select an area for entering input information such as a parameter.

The input key part 1130 includes a ten-key pad, character input keys, and function keys such as a background elimination process function instruction key for instructing background elimination process on image information of an original, an enter key for entering an item (alternative) selected from among items such as alternatives displayed on the display part 1110, and an instruction key for giving an instruction for copying.

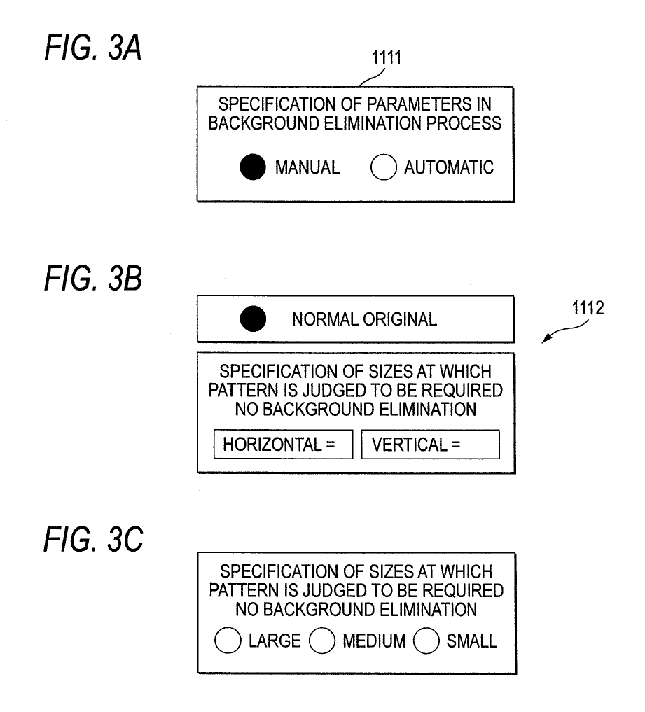

When the background elimination process function instruction key of the input key part 1130 is depressed by a user, as shown in FIG. 3A, display content 1111 is displayed on the display part 1110 to accept the specification of “a parameter in the background elimination process”. Then, the user operates the operation panel portion 1100 to specify that the parameter will be manually input or that the parameter will be automatically input.

When it is specified that the parameter will be specified manually, as shown in FIG. 3B, display content 1112 is displayed on the display part 1110 to accept the specification of “sizes at which a pattern is judged to be requiring no background elimination” in the case of a normal original. Then, the user operates the operation panel portion 1100 to specify a length (numerical value) in the horizontal direction and a length (numerical value) in the vertical direction.

Although it has been stated that sizes at which a pattern is judged to be requiring no background elimination are specified as “numerical values indicating horizontal and vertical sizes”, desired items may alternatively be specified (selected) from among alternatives (items) “large”, “medium”, and “small” representing sizes, as shown in FIG. 3C.

In the present specification, the term “normal original” means an original which is constituted by a single image of one type including an image having unevenness (variation) of background level.

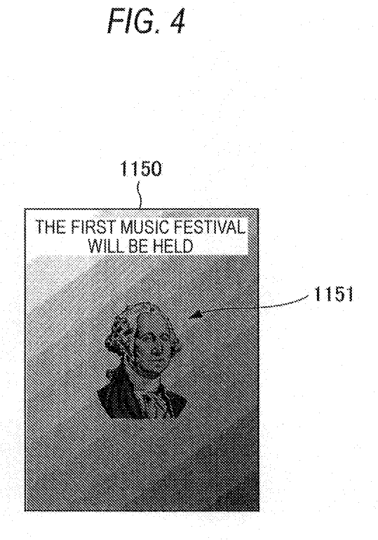

For example, as shown in FIG. 4A, a normal original 1150 is constituted by a single image of one type including an image 1151 having unevenness (variation) of background level. Normal originals frequently include pictures and marks for which background elimination is not required.

The user input unit 110 also allows the input of fine adjustments of image quality, e.g., adjustment values for background level, density level, contrast, and sharpness.

The description will be continued by referring to FIG. 1 again. When a user operates the user input unit 110 to specify that “parameters in background elimination process” will be “manually” specified (see FIG. 3A) and the parameters are input, the input parameters are stored in the parameter storage unit 120 (see FIG. 3B).

“Parameters in background elimination process” are stored in the parameter storage unit 120 as default values. When it is specified that “parameters in background elimination process” will be “automatically” specified, reference is made to the default values.

Contents stored as parameters 120 are referred to by a background level detecting portion 1510 of the image processing unit 150 which will be described later.

The image acquisition unit 130 receives (obtains) image data (image information) of an original read by an image forming apparatus or scanner apparatus having a copying function or scanning function and also receives (obtains) image data (image information) from a host computer which has obtained image data read by such apparatus.

The storage units 141, 142, and 143 store data obtained during and after image processing performed by the image processing unit 150 which will be described later.

The image storage unit 144 stores image data obtained by the image acquisition unit 130.

The image processing unit 150 performs background elimination process, which will be detailed later, on image data (image information) obtained by the image acquisition unit 130.

The image output unit 160 has a function of outputting the image data which has been subjected to the image processing (the background elimination process) at the image processing unit 150 to a processor, a computer, and a printer which perform subsequent image processing.

The image processing unit 150 will now be described in detail.

The image processing unit 150 obtains plural pieces of density information on background of image data (image information) to be processed, for plural different detection process units in detection process of background density of the image data, and eliminates the background from the image data based on the plural pieces of density information for the plural detection process units.

At this time, the image processing unit 150 obtains background density reference information that is information on the elimination of the background of the image data to be processed based on the plural pieces of density information obtained for the plural detection process units, and performs the background elimination process at each pixel of the image data (a process of eliminating pixel density information) based on the background reference density information.

In the present specification, the term “plural different detection process units” means plural image regions which have N pixels in an X-direction (main scanning direction) and M pixels in a Y-direction (sub scanning direction) (which are image regions formed by N pixels×M pixels) and which are different from each other in the number of pixels in at least either of the X- and Y-directions, among image regions formed by plural pixels constituting image data (pixel data).

In the present specification, when the “plural image regions” can be constituted by first and second image regions, for example, each image region is determined to satisfy the relationship that “the second image region is greater than the first image regions”. Therefore, the “different plural detection process units” i.e., the “plural detection process units” also satisfy the relationship that “a second detection process unit in the second image region is greater than the first detection process unit in the first image region”.

In the present specification, the “first detection process unit” is defined as “a small area”, and the “second detection process unit” is defined as “a large area”.

The small area (the first detection process unit) may have a size that is determined in advance according to the size of the original. Alternatively, the area may have a size that is determined based on input information specified by a user through an input operation on the user input unit 110.

In the case of a normal original, the size of the large area (the second detection process unit) is determined by adding “the (horizontal and vertical) sizes at which a pattern is judged to be requiring no background elimination” set by a user through an input operation on the user input unit 110 and a preset adjustment value. Alternatively, the size may be determined by multiplying the “the (horizontal and vertical) sizes at which a pattern is judged to be requiring no background elimination” by a real number greater than 1 (e.g., 2).

In the present specification, for example, the “first image region” has a size of “256 pixels×256 pixels”, and the “second image region” has a size obtained by multiplying “2362 pixels×2362 pixels” by a real number. Those specific values of the image regions are merely examples, and the invention is not limited to those values.

“256 pixels×256 pixels” is a value based on an assumption that an original is read at a resolution of 600 dpi (dots/inch) or a transferred image of the original has the resolution of 600 dpi and that the size of a pattern of interest (e.g., a pattern for which background elimination is not required) included in the original is 100 mm wide and 100 m long.

That is, the relationship between the length of an image and the number of pixels of the same is represented by the following relational equation using the resolution of the image.

The number of pixels (dots)=length (or width) [mm]÷25.4 [mm]×resolution [dpi]

Therefore, in the above-described example, the numbers of pixels in the widthwise and lengthwise directions of the pattern are given as follows.

Number of pixels=100÷25.4×600=2362.2 which nearly equals 2362

Image regions as described above will now be more specifically described. Image regions will be described as having small sizes for simplicity.

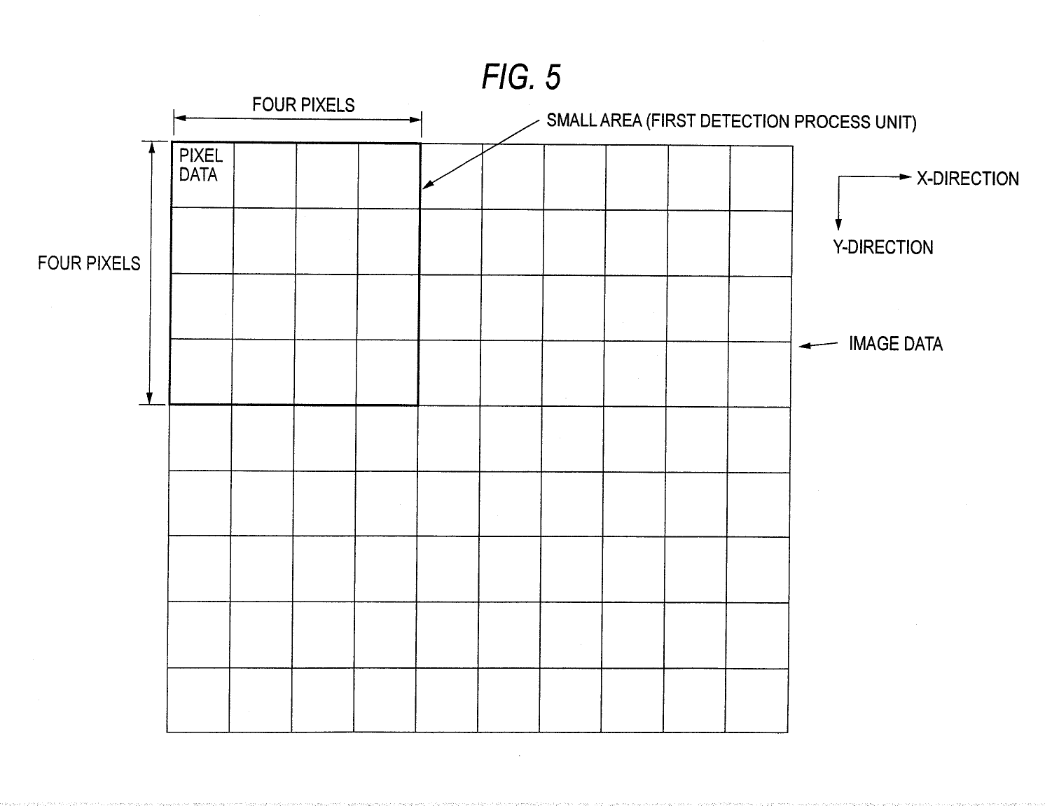

For example, “a first image region” is an image region which is formed by N=4 pixels in the X-direction and M=4 pixels in the Y-direction (and which therefore has 16 pixels) as shown in FIG. 5 (in practice, the image region may have a size of, for example, “256 pixels×256 pixels”). Such a first image region represents a certain image region to be subjected to a process of detecting density information on the background of image data. A unit used for the process of detecting the first image region constitutes “a first detection process unit”.

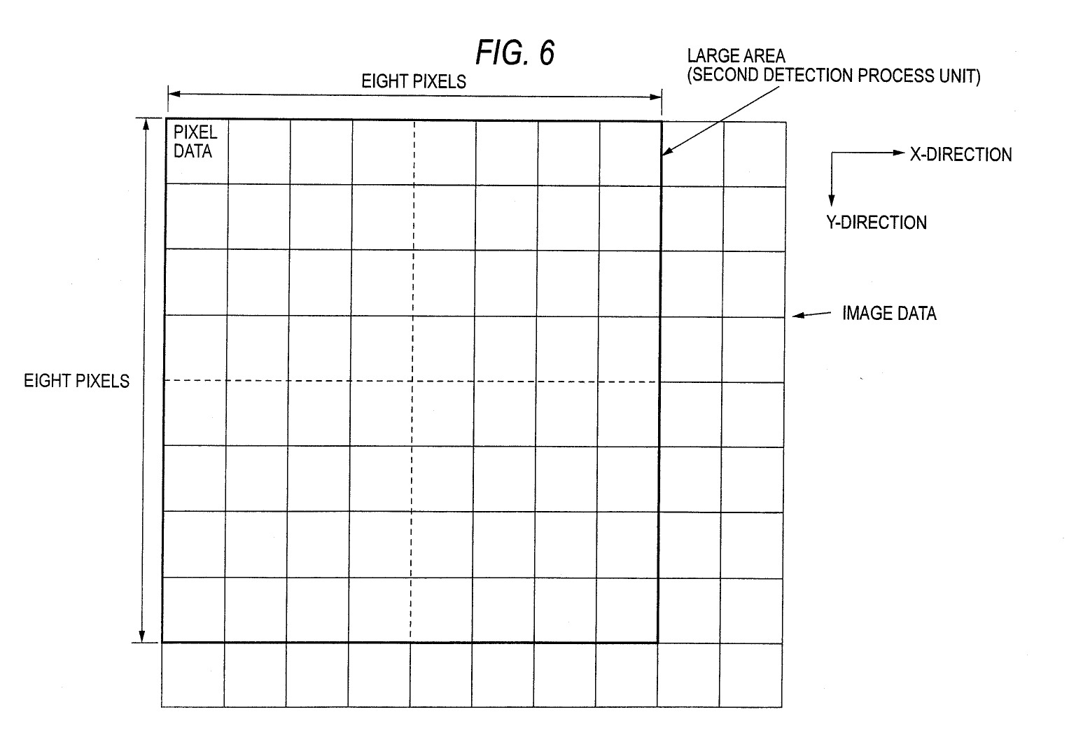

“A second image region” is an image region which is formed by N=8 pixels in the X-direction and M=8 pixels in the Y-direction (and which therefore has 64 pixels) as shown in FIG. 6 (in practice, the image region may have a size of, for example, “2362 pixels×2362 pixels”). Such a second image region represents a certain image region to be subjected to the process of detecting density information on the background of image data. A unit used for the process of detecting the second image region constitutes “a second detection process unit”.

As shown in FIG. 1, the image processing unit 150 includes a background level detecting portion 1510 which has a function of detecting the background density, a background level processing portion 1520 which has a function of processing the background density, and a background eliminating process portion 1530 which has a function of eliminating the background.

The background level detecting portion 1510 has a function of detecting density information on the background of image data to be processed, the detecting being performed using each detection process unit for an image region to be subjected to the process of detecting the density information of the background of the image data.

The background level detecting portion 1510 as thus described includes a small area background level detecting part 1511 and a large area background level detecting part 1512, which are associated with plural detection process units to be used for image regions having different sizes (see FIGS. 5 and 6).

The small area background level detecting part 1511 detects density information on the background of image data in each small area (which is equivalent to the first image region and which constitutes the first detection process unit) (see FIG. 5) and saves the result of the detection process (background density information) in the storage unit 141.

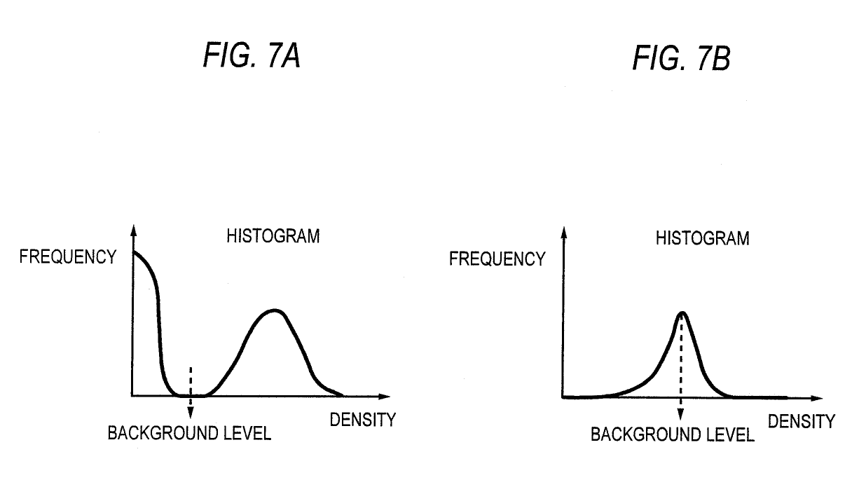

Specifically, the small area background level detecting part 1511 creates a histogram, for example, as shown in FIG. 7A or FIG. 7B based on pixel densities of plural pixels (16 pixels in the example shown in FIG. 5) in the small area and calculates a background level based on such a histogram. When a histogram as shown in FIG. 7A is created, a density value corresponding to points (intermediate points) between peaks of the graph (parts of the distribution where high frequencies are dominant) is calculated as a background level. When a histogram as shown in FIG. 7B is created, a density value corresponding to the maximum frequency is calculated as a background level.

While a histogram is used to detect (calculate) a background level, a background level may alternatively be detected (calculated) using an index such as an average value or intermediate value of pixel densities of plural pixels.

The large area background level detecting part 1512 detects density information on the background of image data in each large area (which is equivalent to the second image region and which constitutes the second detection process unit) which includes the first image region and saves the result of the detection process (background density information) in the storage unit 142.

Specifically, the large area background level detecting part 1512 creates a histogram, for example, as shown in FIG. 7A or FIG. 7B based on pixel densities of a plurality of pixels (64 pixels in the example shown in FIG. 6) in the large area and calculates a background level based on such a histogram in the same manner as in the process of detecting (calculating) a background level performed by the small area background level detecting part 1511.

While a histogram is used to detect (calculate) a background level, a background level may alternatively be detected (calculated) using an index such as an average value or intermediate value of pixel densities of a plurality of pixels.

The large area background level detecting part 1512 may detect a background level based on a detection method (calculation method) different from that of the small area background level detecting part 1511. For example, when the small area background level detecting part 1511 uses a histogram as an index, the large area background level detecting part 1512 may use an average value or intermediate value as an index. When the small area background level detecting part 1511 uses a histogram as shown in FIG. 7A as an index, the large area background level detecting part 1512 may use a histogram as shown in FIG. 7B as an index.

In the present specification, “first background density detection information” representing the result of the detection process performed by the small area background detecting part 1511 (background density information) is defined as “small area background level information”, and “second background density detection information” representing the result of the detection process performed by the large area background detecting part 1512 (background density information) is defined as “small area background level information, “first background density detection information” representing the result of the detection process performed by the small area background detecting part 1511 (background density information) is defined as “large area background level information”.

Therefore, the small area background level information (first background density detection information) is stored in the storage unit 141, and the large area background level information (second background density detection information) is stored in the storage unit 142.

The background level processing portion 1520 has a function of acquiring background density reference information that is information on the elimination of background of image data to be processed based on plural pieces of density information detected by the background level detecting portion 1510, i.e., the small area background level information and the large area background level information.

The background level processing portion 1520 includes a background density adjusting part 1521 which has a function of adjusting the background density adjusting and a background density determination part 1522 which has a function of determining the background density.

The background density adjusting part 1521 has a function of adjusting the large area background level information (second background density detection information) of the second image region corresponding to the large area (second detection process unit).

The background density adjusting part 1521 adjusts the large area background level information using the small area background level information (first background density detection information). For this reason, the image storage unit 144 has as a storage capacity sufficient to store image data of an image region which is at least formed with a length in the Y-direction equivalent to the length of the large area in the Y-direction and a length in the X-direction equivalent to the width of one line. Obviously, the image storage unit 144 may have a storage capacity sufficient to store all image data.

Specifically, the background density adjusting part 1521 performs processes described in items (1-1) to (1-3) below.

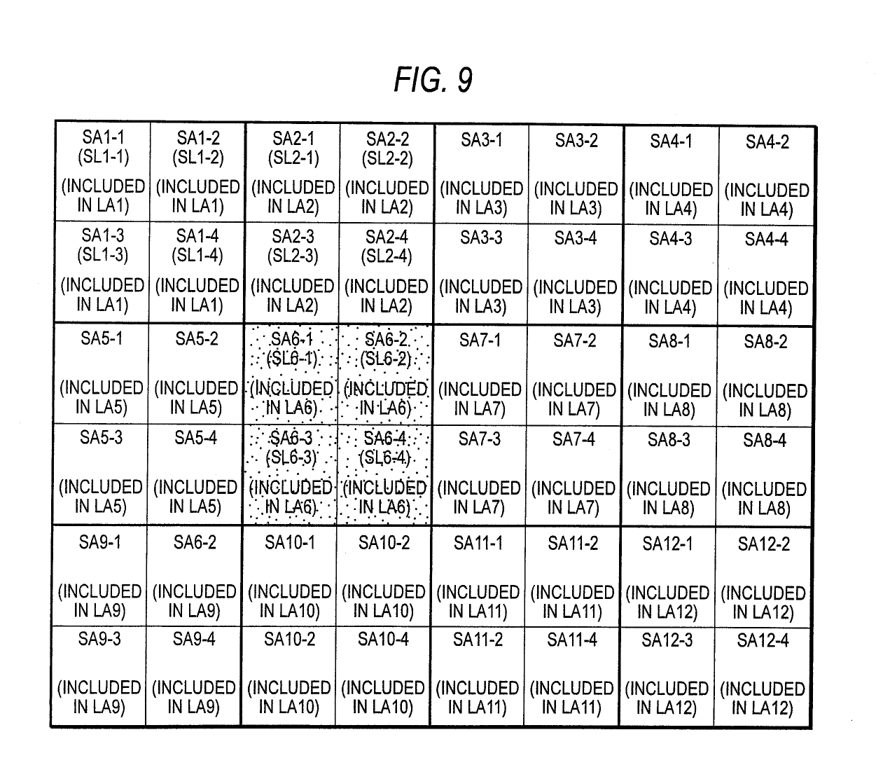

The processes will now be specifically described with reference to FIG. 9. In FIG. 9, SA1-1 to SA1-4, SA2-1 to SA2-4, . . . , SA12-1 to SA12-4 represent image regions corresponding to small areas (hereinafter referred to as “small area image regions”). SL1-1 to SL1-4 represent small area background level information of respective small area image regions. SL2-1 to SL2-4 and SL6-1 to SL6-4 represent small area background level information of respective small area image regions. It is assumed that there is small area background level information of other small area image regions.

Referring to FIG. 9, for example, the description reading “included in LA-1” in the square regions designated by SA1-1 to SA1-4 means that the small area image regions SA1-1 to SA1-4 are included in an image region LA1 corresponding to a large area (hereinafter referred to as “large area image region”). For example, the description reading “included in LA6” in the square regions designated by SA6-l to SA6-4 means that the small area image regions SA6-1 to SA6-4 are included in a large area image region LA6. This applies to the description in other small area image regions. It is assumed that large area background level information of the large area image region LA6 is represented by LL6.

(1-1) The value of a difference between large area background level information relating to a second image region of interest corresponding to a large area and an average value of small area background level information relating to the second image region of interest (first background density detection information) is equal to or greater than a threshold Δa. Then, the large area background level information relating to the second image region of interest is adjusted based on large area background level information of other second image areas in the vicinity of the second image area of interest.

Specifically, when the second image region of interest is, for example, the large area image region LA6, a difference between the large area background level information LL6 of the large area image region LA6 and an average value of four pieces of small area background level information SL6-1 to SL6-4 associated with the four small area image regions SA6-1 to SA6-4 included in the large area image region LS6 is obtained.

That is, the absolute value of a value {LL6−(“SL6-1”+“SL6-2”+“SL6-3”+“SL6-4”)/4} is obtained.

When the value of the difference (absolute value) thus obtained is equal to or greater than the threshold Δa (when a relationship “difference value (absolute value)≧ threshold Δa)” is true), large area background level information of a large area image region among large area image regions LA1, LA2, LA3, LA5, LA7, LA9, LA10, and LA11 located in the vicinity of the large area image region LA6 (located on the left and right side of, above and under, and diagonally to the image region LA6) is adopted as large area background level information or adjusted large area background level information LL6 of the large area image region LA6 corresponding to the second image region of interest.

The “adjusted large area background level information LL6” is defined as “large area background level information LL6#”.

(1-2) In the process (1-1) described above, an average value of second background density detection information relating to the other second image regions in the vicinity of the second image region of interest is adopted as second background density detection information relating to the second image region of interest. There is an alternative to adopt the second background density detection information which is smallest in the value of difference from the second background density detection information relating to the second image region of interest among the pieces of second background density detection information relating to the other second image regions in the vicinity of the second image region of interest.

Specifically, for example, an average value of large area background level information of the eight large area image regions LA1, LA2, LA3, LA5, LA7, LA9 LA10, and LA11 corresponding to the other image regions is adopted as the large area background level information (adjusted large area background level information LL6#) of the large area image region LA6 corresponding to the second image region of interest. An alternative is to adopt the large area background level information which is smallest in the value of difference (absolute value) from the large area background level information LL6 of the large area image region LA6 among the pieces of large area background level information of the eight respective large area image regions.

The value of the difference (absolute value) between the large area background level information LL6 of the large area image region LA6 and large area background level information LL3 of the large area image region LA3 is smallest when compared to the difference values between the information LL6 and the large area background level information of the other seven large area image regions. Then, the large area background level information LL3 of the large area image region LA3 is adopted as the large area background level information of the large area image region LA6 (adjusted large area background level information LL6#).

(1-3) In the process described in the item (1-1), when the value of the difference between the second background density detection information (large area background level) of the second image region of interest and the average value of the pieces of first background density detection information corresponding to the second image region of interest is smaller than the predetermined threshold Δa, the second background density detection information is adopted for the second image region of interest.

Specifically, for example, the absolute value of {LL6−(“SL6-1”+“SL6-2”+“SL6-3”+“SL6-4”)/4} is obtained as in the specific example in the item (1-1). When, the absolute value (difference value) is smaller than the threshold Δa (when the relationship that “the difference (absolute value)<the threshold Δa” is true, the large area background level information LL6 of the large area image region LA6 associated with the second image region of interest is adopted as it is. The large area background level information LL6 constitutes the large area background level information LL6#.

The background density determination part 1522 has a function of determining background density reference information relating to image data to be processed. This part determines background density reference information for first image regions corresponding to an image region on which the determination process is to be performed based on the large area background level information (second background density detection information) adjusted by the background density adjusting part 1521 and the small area background level information (first background density detection information).

That is, background density reference information is determined for first image regions corresponding to an image region on which a process is to be performed to determine information on the density of background associated therewith, the reference information being determined for each unit (small area) of determination process.

In the present specification, the term “unit of determination process” means the “first detection process unit” or “small area”. Obviously, the “unit of determination process” may be the “second detection process unit” or “large area”, and the unit may alternatively be an area having a different size.

In the present specification, the term “image area on which a determination process is to be performed” means “a first image region” corresponding to a small area because “the unit of determination process” means a small area (first detection process unit).

In this regard, the term “first image region corresponding to the image region on which the determination process is to be performed” means a first image region including the whole or part of the image region on which the determination process is to be performed. Specifically, when the size of the image region on which the determination process is to be performed is different from the size of the first image region, the first image region is a first image region including the whole or part of the image region on which the determination process is to be performed. When the image region on which the determination process is to be performed has the same size as the first image region, the first image region is a first image region which includes the entire image region on which the determination process is to be performed.

In the present specification, when information on the density of background is to be determined for each “unit of determination process” i.e., small area, since the background density determination part 1522 recognizes the “first detection process unit” i.e., “small area” and the “second detection process unit” i.e., “large area”, information on the density of background of small areas in the same large area is determined with priority over small areas in another large area. Information on the density of background of the small areas in the other large area is thereafter determined.

For example, in the example shown in FIG. 9, when the image region “SA1-1” is chosen as the starting area of a determination process, the small area as the unit of determination process moves from the region “SA1-1” to the regions “SA1-2”, “SA1-3”, and “SA1-4” sequentially. Then, the small area then sequentially moves to the regions “SA2-1”, “SA2-2”, “SA2-3”, and “SA2-4”. The small area does not move in such an order that it sequentially moves from the region “SA1-1” to “SA1-2”, det “SA2-1”, “SA2-2”, and so on.

The background density determination part 1522 performs processes as described in items (2-1) and (2-2) below.

(2-1) For each unit of determination process relating to a process of determining density information on the background of image information, comparison is made between small area background level information representing the result of the detection process performed by the small area background detecting part 1511 on a first image area corresponding to the image region under the determination process and large area background level information that is adjusted large area background level information representing the result of the detection process performed by the large area background level detecting part 1512 on a second image region including the first image region. When the value of a difference between those pieces of background level information equals or exceeds a threshold Δb, the large area background level information is determined to be background density reference information for the image region under the determination process or the first image region.

(2-2) When the value of a difference between the small area background level information and the adjusted large area background level information is smaller than the threshold Δb in the process described in the above item (2-1), the small area background level information is determined to be background density reference information for the image region under the determination process or the first image region.

In Embodiment 1, when the background density determination part 1522 determines background density reference information, adjusted large area background level information obtained by the background density adjusting part 1521 is used. Alternatively, it is possible to use large area background level information which has not been adjusted by the background density adjusting part 1521 or large area background level information detected by the large area background level detecting part 1512 as it is.

However, in order to improve the accuracy of the background elimination process, it is preferable to obtain background density reference information using adjusted large area background level information obtained by the background density adjusting part 1521.

The processes of the items (2-1) and (2-2) will now be specifically described. For example, the small area as a unit of determination process in FIG. 9 sequentially moves from the region “SA1-1” to the regions “SA1-2”, “SA1-3”, and “SA1-4”. Then, the background density determination part 1522 identifies a difference between adjusted large area background level information LL1# of the large area image region LA1 including those small area image regions and small area background level information “SL1-1” of the small area image region “SA1-1”.

Next, when the value of the difference (absolute value) is equal to or greater than the threshold Δb (or when the relationship “the difference value (absolute value)≧Δb” is true), the background density determination part 1522 determines the adjusted large area background level information LL1# as background density reference information for the image region under the determination process or the small area image region “SA1-1”.

Similarly, differences between the other small area image regions “SA1-2”, “SA1-3”, “SA1-4” and the large area background level information LL1# are identified, and the process is performed according to the result of the comparison between the difference values (absolute values) and the threshold Δb.

The background elimination process part 1530 eliminates background at each pixel of image data to be processed based on background density reference information obtained by the background level processing part 1520 (the part performs a background elimination process). That is, pixel density information (background density information) of the image data is eliminated.

The above-described image processing unit 150 is implemented by executing software (a program) for achieving the function of the image processing unit 150 with a controller such as a central processing unit. The image acquisition unit 130 and the image input unit 160 may be implemented by executing software (programs) for achieving respective functions of the units with a controller such as a central processing unit. Those units may alternatively be implemented on a hardware basis.

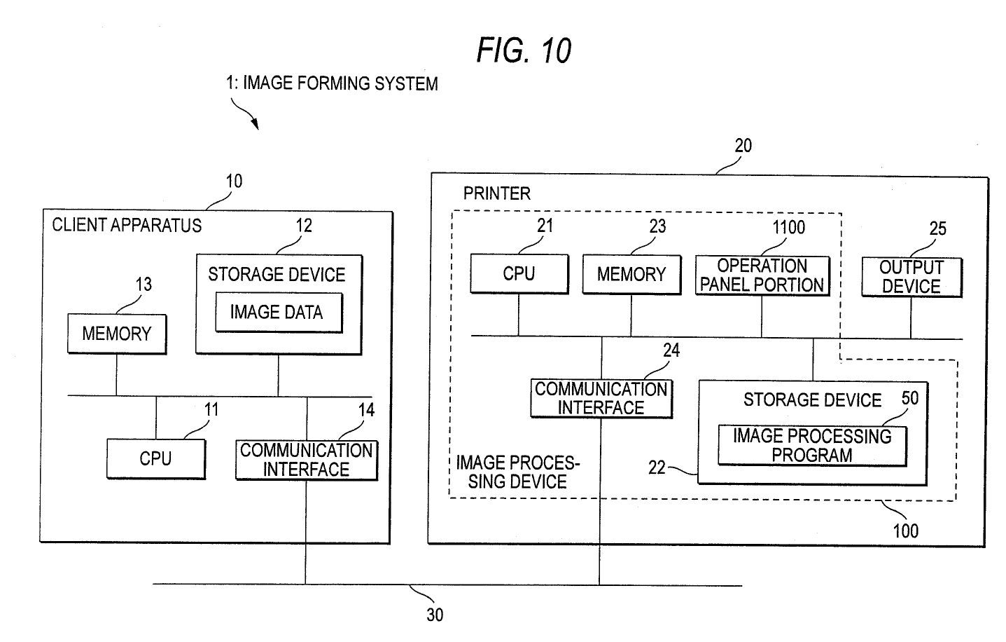

FIG. 10 shows a configuration of an image forming system including an image forming apparatus which has an image processing device 100 as described above.

As shown in FIG. 10, in an image forming system 1, a client apparatus 10 such as a computer and a printer 20 as the image forming apparatus are connected through a communication network 30.

The client apparatus 10 serves as a processor and includes a CPU (Central Processing Unit) 11 a storage device 12 such as a hard disk, a memory 13 such as a RAM (Random Access Memory), and a communication interface 14.

Various types of programs and data are stored in the storage device 12 including programs for implementing the functions of the client apparatus, a printer driver, and image data associated with predetermined original documents.

Programs and data read from the storage device 12 are stored in the memory 13.

The communication interface 14 is an interface for allowing data to be transmitted and received to and from the printer 20 through the communication network 30.

The CPU 11 controls the client apparatus 10 as a whole, and reads a printer driver into the memory 13 from the storage device 12 to execute the same.

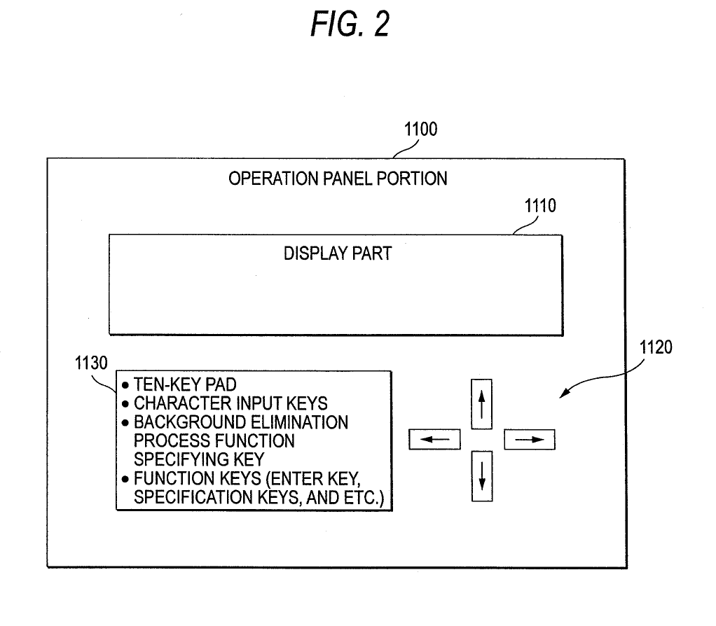

The printer 2 serving as an image forming apparatus includes a CPU 21, a storage device 22 such as a hard disk, a memory 23 such as a RAM, a communication interface 24, an image processing device 100 having an operation panel portion 1100 as shown in FIG. 2, and an output device 25.

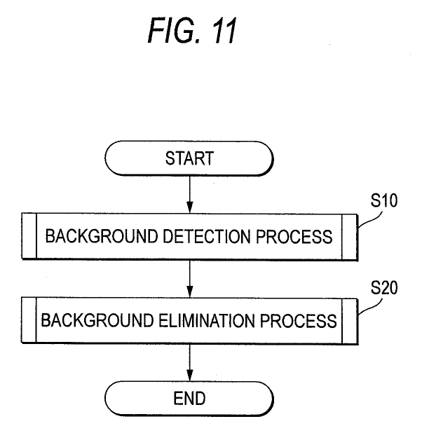

Various programs and parameters required for executing a printing process are stored in the storage device 22 including an image processing program (software) 50 for implementing the functions of the image processing unit 150 and programs associated with processing steps to be described later (shown in FIGS. 11, 12, 16, and 17).

The communication interface 24 is an interface which allows data to be transmitted and received to and from the client apparatus 10 through the communication network 30. For example, printing information (image data) transmitted from the client apparatus 10 is received.

The image processing program 5C read from the storage device 22, the printing information received through the communication interface 24, and image data are stored in the memory 23.

The memory 23 has the functions of the storage units 141, 142, and 143 and the image storage unit 144. A storage area for storing image data obtained by the image acquisition unit 130 is allocated in the memory 23. Other storage areas are also allocated including storage areas required for executing image processing with the image processing unit 150, i.e., a storage area for storing results of the detection process performed by the background level detecting portion 1510 and a storage area for storing results of the background density adjusting process and the background density determination process performed by the background level processing portion 1520.

The CPU 21 controls the printer 20 as a whole and, for example, it reads the image processing program 50 from the storage device 22 into the memory 23 to execute the same, whereby image data of high quality is generated and output to the output device 25.

The output device 25 is an image forming process unit for executing an image forming process, and the device performs a printing process based on image data that it has accepted.

The communication network 30 may be a wire communication network such as a local area network (LAN) or telephone network, a radio communication network such as a radio LAN, or a combination of such communication networks.

Image processing performed by the image processing device 100 will now be described with reference to FIG. 11.

FIG. 11 is a flow chart showing processing steps of the image processing.

The image processing unit 150 reads parameters associated with background elimination process from the parameter storage unit 120, performs background detecting process on image data obtained from a scanner apparatus or computer in each detection process unit based on the read parameters (step S10), and performs the background elimination process for each pixel of the image data based on the result of the background detecting process (step S20).

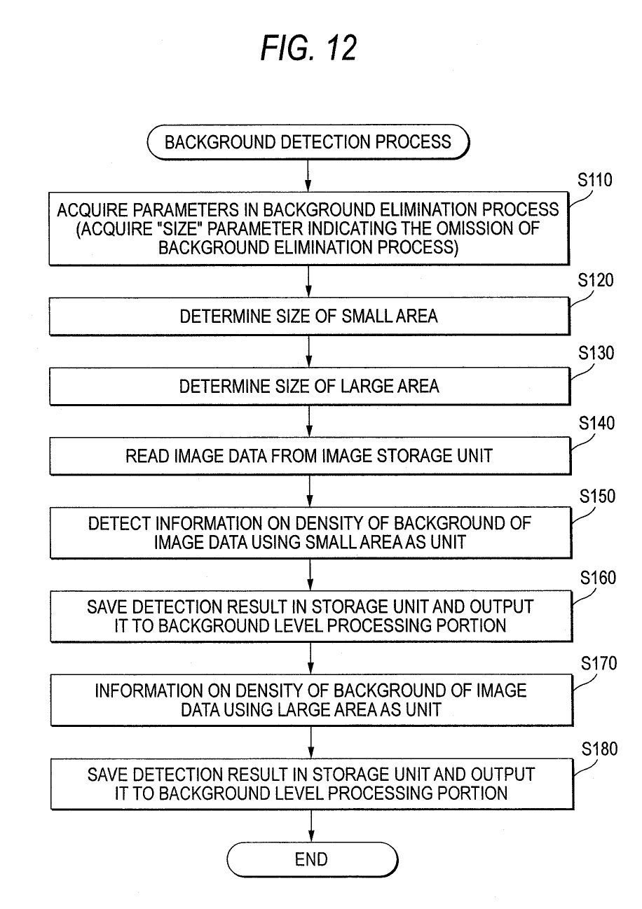

The background detecting process performed by the image processing unit 150 of the image processing device 100 will now be described with reference to FIG. 12.

FIG. 12 is a flow chart showing processing steps of the background detecting process.

It is assumed here that contents (sizes at which a pattern is judged to be requiring no background elimination) as shown in FIG. 3B have been stored in the parameter storage unit 120 through an input operation on the user input unit 110 by a user.

It is assumed that image data to be processed from a scanner apparatus or computer obtained by the image acquisition unit 130 has been stored in the parameter storing unit 120.

The background level detecting portion 1510 of the image processing unit 150 obtains parameters in the background elimination process from the parameter storage unit 120. For example, it reads “size” parameters associated with a judgment that the background elimination process is not required (step s110).

Next, the background level detecting portion 1510 determines the size of a small area as the first detection process unit based on the parameters thus read (the sizes at which a pattern is judged to be requiring no background elimination process) (step S120) and also determines the size of a large area as the second detection process unit (step S130).

For example, it is assumed based that the size of a small area is determined to be the same as that of the small area shown in FIG. 5, i.e., the size of a small area corresponding to an image region of “4 pixels×4 pixels=16 pixels” based on the read parameters. It is also assumed that the size of a large area is a real-number multiple (an integral multiple) of the size of a small area. For example, it is assumed that the large area size is determined to be the same as that of the large area shown in FIG. 6, i.e., the size of a large area corresponding to an image region of “8 pixels×8 pixels=64 pixels”.

When the sizes of small and large areas are determined as thus described, the small area background level detecting part 1511 and the large area background level detecting part 1512 of the background level detecting portion 1510 read image data from the image storage unit 144 (step S140).

The small area background level detecting part 1511 of the background level detecting portion 1510 detects density information on the background (background level) of the read image data in small areas determined at step S120 (step S150) serving as units. The result of the detection is saved in the storage unit 141 and output to the background level processing portion 1520 (step S160).

The large area background level detecting part 1512 detects density information on the background (background level) of the read image data in large areas determined at step S120 (step S150) serving as units. The result of the detection is saved in the storage unit 141 and output to the background level processing portion 1520 (step S160).

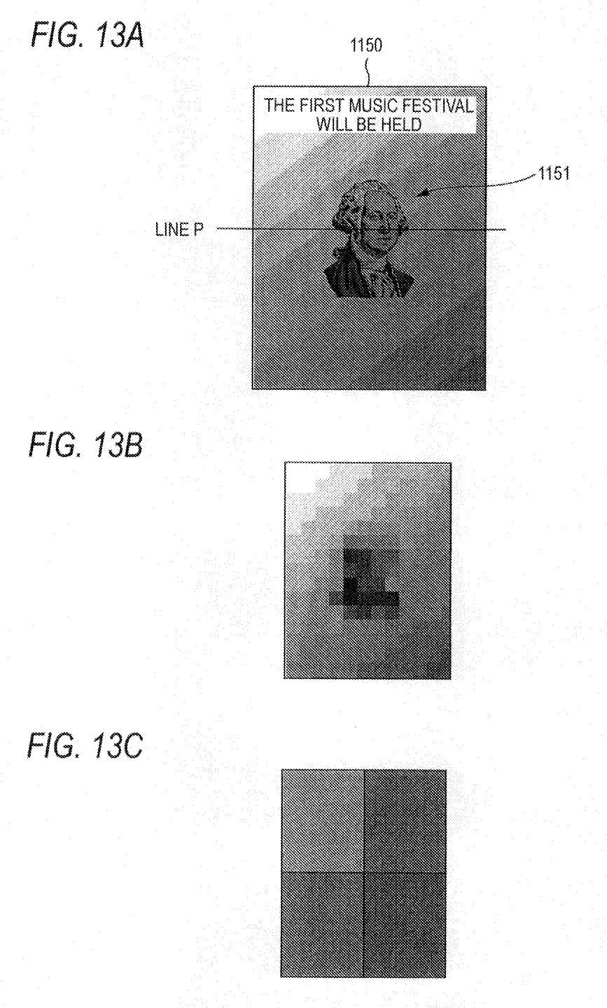

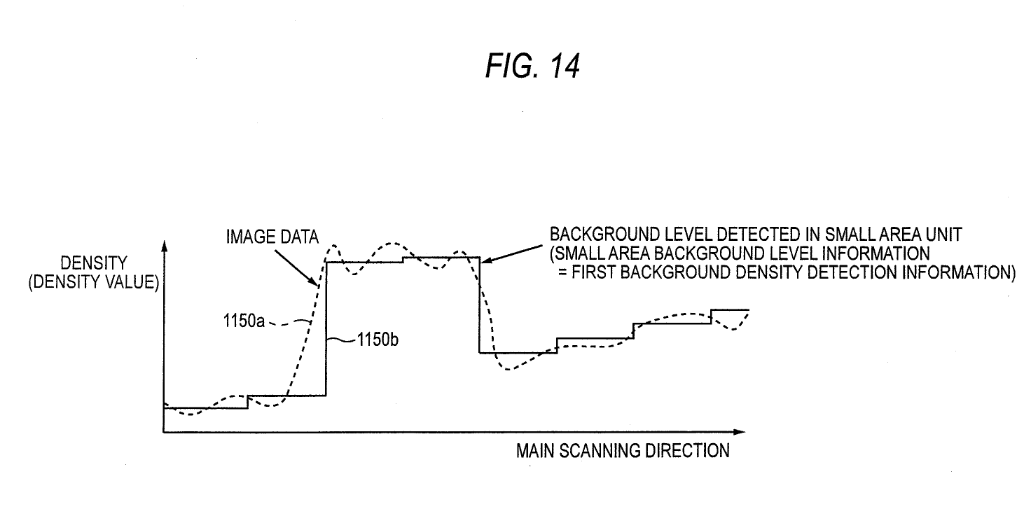

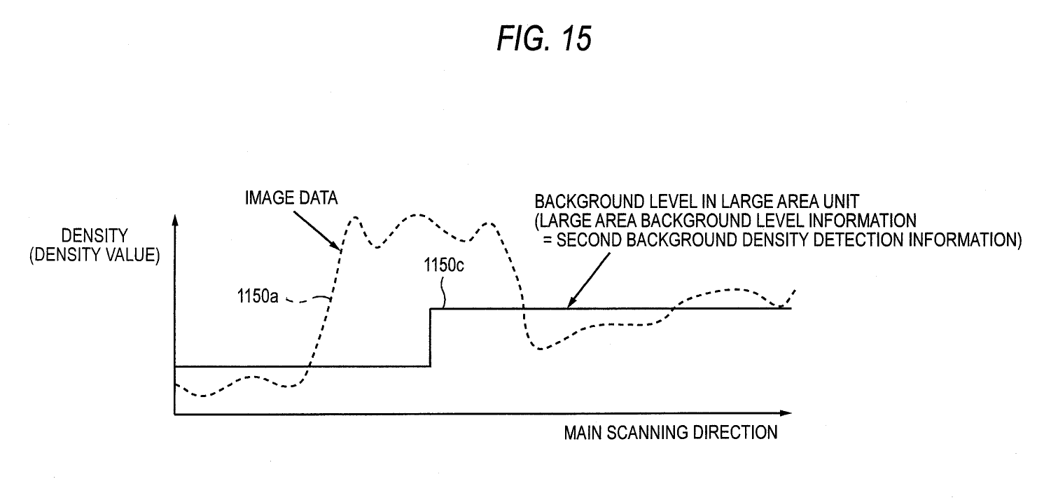

The image data to be processed (which is an image of a normal original) is the image shown in FIG. 4 and that the background level detecting portion 1510 detects density information on the background of the image in the part indicated by the line P in FIG. 13A. Also, the result of the detection process performed by the small area background level detecting part 1511 is small area background level information 1150b as shown in FIG. 14 and that the result of the detection process performed by the large area background level detecting part 1512 is large area background level information 1150c as shown in FIG. 15.

In FIGS. 14 and 15, the vertical axis represents densities (density values) corresponding to 256 gradations having values from “0” to “256”. The reference numeral 1150a represents (density information of) items of image data associated with the image in the part of the line P among the image data to be processed.

At least the image data 1150a (the image data associated with the part of the line P) among the image data to be processed is stored in the image storage unit 144 prior to the detection process. The small area background level information 1150b is stored in the storage unit 141 as the result of the detection process, and the large area background level information 1150c is stored in the storage unit 142 as the result of the detection process.

An image output based on the small area background level information 1150b (see FIG. 14) detected by the small area background level detecting part 1511 has contents as shown in FIG. 13B and that an image output based on the large area background level information 1150c (see FIG. 15) detected by the large area background level detecting part 1512 has contents as shown in FIG. 13C.

In the detection process performed using small areas as units, as will be apparent from the contents shown in FIG. 13B, density information (density level) on the background of a portrait 1151 itself is detected as background. Therefore, the object of background elimination will include a part which should not be judged to be background.

In the detection process performed using large areas having a size that is a real-number multiple (integral multiple) of the size of a small area as units, as will be apparent from the contents shown in FIG. 13C, background is detected in image regions in a range that is an integral multiple of the range of the small areas. The background density information (background level) extracted will be somewhat rough in that very small variations in density in the part of the portrait 1151 will not be captured.

When background is detected in large areas, plural pieces of large area background level information corresponding to second image regions (image regions corresponding to large areas) adjacent to each other may not be captured as a smooth change in background when compared to information obtained by background detection performed in small areas. Therefore, the large area background level information is adjusted as described later.

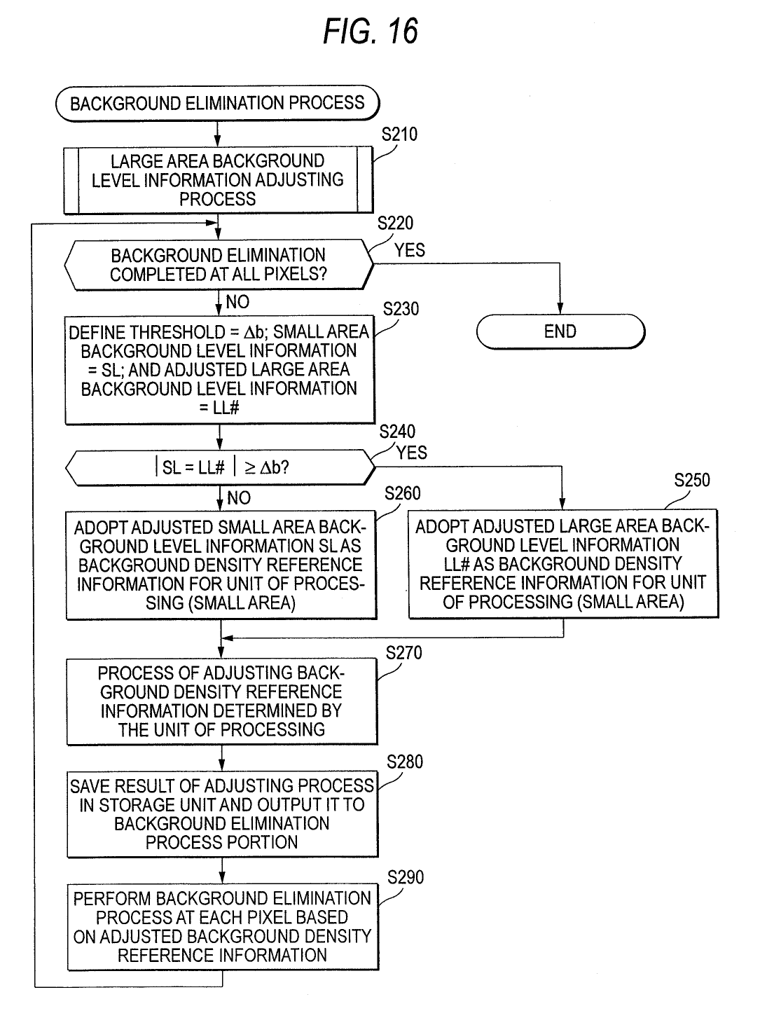

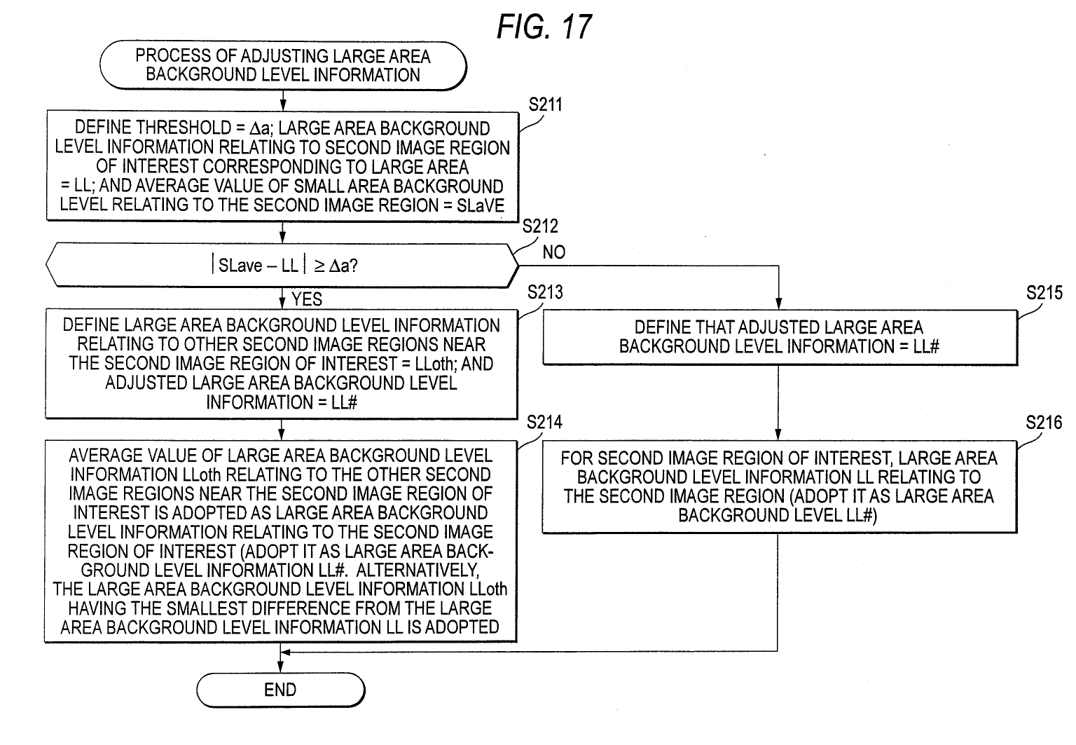

The background elimination process performed by the image processing unit 150 of the image processing device 100 will now be described with reference to FIGS. 16 and 17.

FIG. 16 is a flow chart showing processing steps of the background elimination process, and FIG. 17 is a flow chart showing processing steps of a process of adjusting large area background level information, the adjusting process being included in the background elimination process.

In the background level processing portion 1520 of the image processing unit 150, the background density adjusting part 1521 performs the process of adjusting the large area background level information based on the result of the detection of background density information output by the small area background level detection part 1511 and the large area background level detecting part 1512 (step S210) and outputs the result of the adjusting process to the background density determination part 1522.

The process of adjusting large area background level information performed by the background density adjusting part 1521 will now be described with reference to FIG. 17.

As shown in FIG. 17, in the background density adjusting part 1521, it is defined that the threshold is represented by Δa; large area background level information relating to a second image region of interest corresponding to a large area is represented by LL; and an average value of pieces of small area background level information relating to the second image area is represented by SLave (step S211).

Next, the background density adjusting part 1521 determines whether the absolute value (|SL−LL|) of a difference between the average value SLave of small area background level information advised by the small area background detecting part 1511 and the large area background level information LL advised by the large area background detecting part 1512 is equal to or greater than the threshold Δa. That is, it is determined whether a relational expression “|SLave−LL|≧Δa” is true or not (step S212).

When it is determined that the relational expression is true at step S212, in the background density adjusting part 1521, it is defined that pieces of large area background level information relating to other second image regions in the vicinity of the second image region of interest are represented by LLoth and that adjusted large area background level information is represented by LL# (step S213).

Thereafter, the background density adjusting part 1521 adopts an average value of the pieces of large area background level information LLoth relating to the other second image regions in the vicinity of the second image region of interest as large area background level information relating to the second image region of interest. The part alternatively adopts the large area background level information LLoth which is the smallest in difference (absolute value) from the large area background level information LL among the pieces large area background level information LLoth (step S214). The adopted large area background level information LLoth constitutes the large area background level information LL#.

On the contrary, when it is determined at step S212 that the relational expression is not true (a relationship “|SLave−LL|<Δa” is true), the background density adjusting part 1521 defines that adjusted large area background level is represented by LL# (step S215). Thereafter, the large area background level information LL relating to the second image region of interest is adopted as large area background level information of the second image region of interest. Thus, the adopted large area background level information LL constitutes the large area background level information LL#.

The process of adjusting large area background level information performed by the background density adjusting part 1521 will not be described here because a specific example has already been shown in the description of processes in the above items (1-1) to (1-3).

Referring to FIG. 16 again, the background density determination part 1522 determines whether the background elimination process has been completed at all pixels (step S220). When it is determined that the background elimination process has been completed at all pixels, the process is terminated. When there is any pixel at which the background elimination process has not been performed, it is defined that the threshold is represented by Δb; small area background level information is represented by SL; and adjusted large area background level information received from the background density adjusting part 1521 is represented by LL# (step S230).

The background density determination part 1522 defines that adjusted large area background level is represented by LL# at step S230. However, when the determination part 1522 can share contents of definitions with the background density adjusting part 1521 or when the determination part 1522 can commonly use the contests of the definition that adjusted large area background level information is represented by LL# made by the background density adjusting part, 1521 at step S213 or step 215, there is no need for defining that adjusted large area background level information is represented by LL# at step S230.

Next, the background density determination part 1522 determines whether the absolute value of a difference between the small area background level information SL and the large area background level information LL# (|SL−LL#|) is equal to or greater than the threshold Δb or whether a relational expression “|SL−LL#|Δb” is true or not (step S240). When it is determined that the relational expression is true (YES at step S240), the adjusted large area background level information LL# is adopted as background density reference information for small areas as units of processing (step S250). When the relational expression is not true (NO at step S240), the small area background level information SL is adopted as background density reference information for small areas as units of processing (step S260).

Subsequently, the background density determination part 1522 performs a process of adjusting the background density reference information determined for the small areas as units of processing (step S270), and the result of the adjusting process is stored in the storage unit 143 and output to the background elimination process portion 1530 (step S280).

The background elimination process portion 1530 reads image data from the image storage unit 144, performs background elimination process on the read image data pixel by pixel based on the adjusted background density information received from the background density determination part 1522 (step S290), and outputs image data, on which the background elimination process has been completed, to the image output unit 160.

In executing the background elimination process, the background elimination process portion 1530 compares the “adjusted background density reference information” and “pixel density information” of the image to be processed and performs the process according to the result of the comparison.

The background elimination process portion 1530 calculates an expression “out=func(d−th)” or “out=func(d)” to obtain an output “out” when a relational expression “d≧th” is true where d represents the adjusted background density reference information and th represents the pixel density information.

The term “func” means a linear or non-linear function used for making gradation adjustments such as contrast enhancement after the background elimination process. The expression “out=func(d−th)” is advantageously used to extend the effect of background elimination throughout the image. The expression “out=func(d)” gives y=x because “func” has a slope of 1, and the expression is therefore advantageously used when density should not be affected by background elimination.

On the contrary, when a relational expression “d<th” is true, the output “out” is nullified (background is completely eliminated).

Then, the background elimination process portion 1530 outputs the output “out” information to the image output unit 160, as above-described.

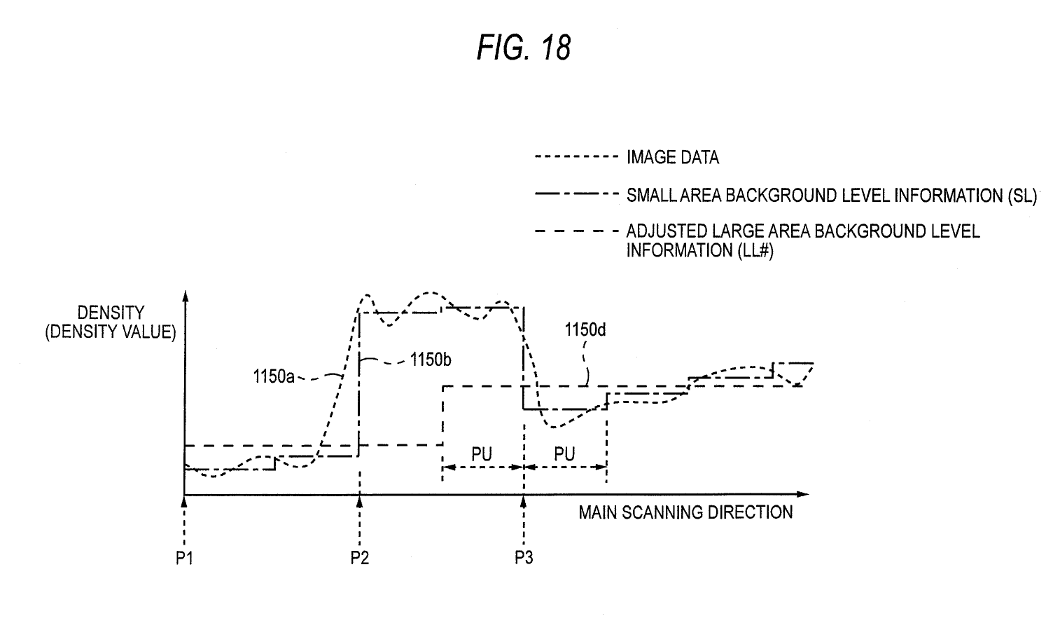

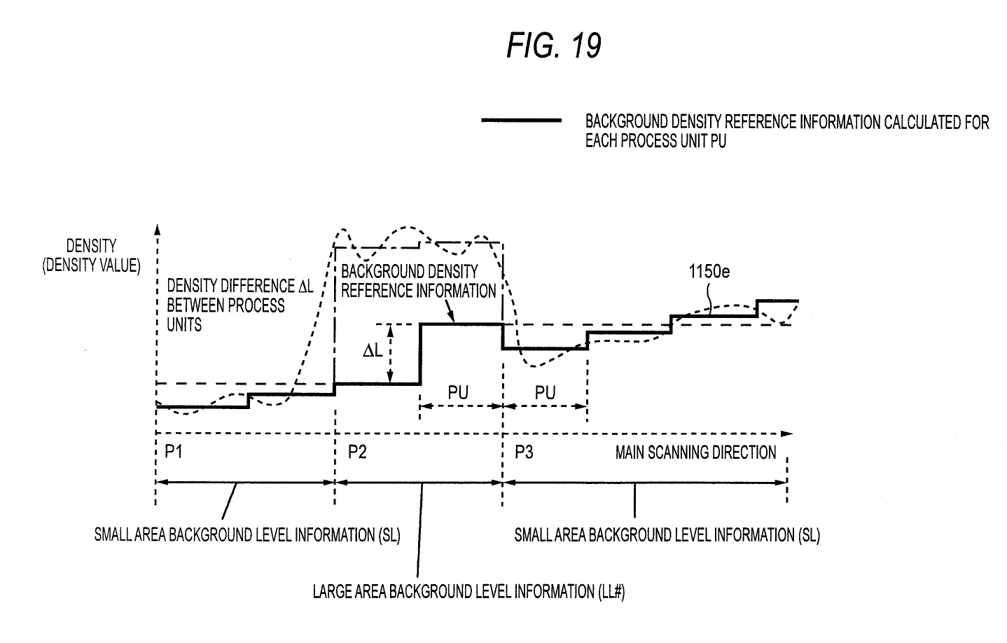

A specific example of the process of adjusting background density information performed by the background density determination part 1522 will be described with reference to FIGS. 18 and 19.

FIG. 18 shows a relationship between small area background level information 1150b (=small area background level information SL) detected by the small area background level detecting part 1511 and adjusted large area background level information 1150d (=large area background level information LL#) obtained through adjustment by the background density adjusting part 1521. PU is an abbreviation meaning a unit of processing which is, for example, the length of a small area in the main scanning direction (X-direction).

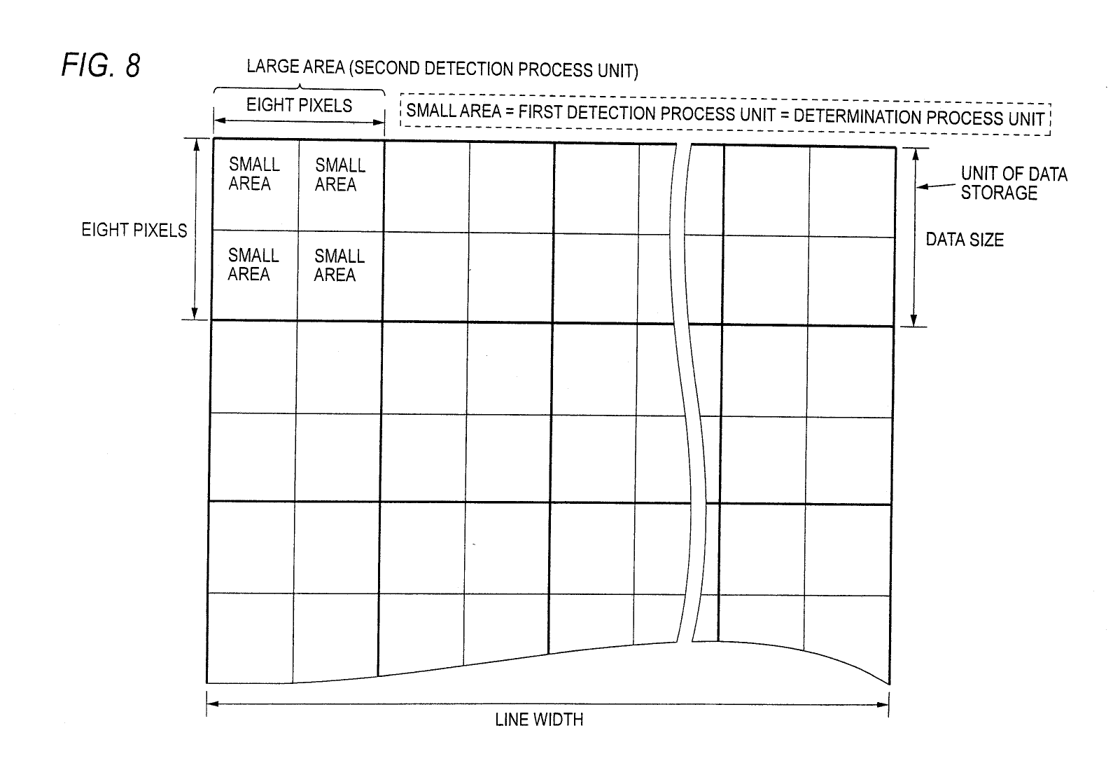

Referring to FIG. 18, when background density reference information is determined for each unit of processing PU of image regions in the main scanning direction of the image data to be processed, it is assumed that the value of the difference (absolute value) between the small area background level information SL (small area background level information 1150b) and the large area background level information LL# (large area background level information 1150d) is smaller than the threshold Δb in an image region extending from a position P1 to a position immediately before a position P2 along the horizontal axis or the main scanning direction (which is, for example, the X-direction in the example shown in FIG. 8). It is also assumed that the difference (absolute value) is equal to or greater than the threshold Δb in an image region extending from the position P2 to a position immediately before a position P3. It is further assumed that the difference (absolute value) is smaller than the threshold Δb in image regions beyond the position P3.

When the background density determination part 1522 determines background density reference information for each unit of processing (small area) PU under those assumptions, the large area background level information LL# is adopted if the difference (absolute value) is equal to or greater than the threshold Δb (if a relationship “difference (absolute value)≧threshold Δb” is true) as shown in FIG. 19. If the difference is smaller than the threshold Δb (if a relationship “difference (absolute value)<threshold Δb” is true), the small area background information SL is adopted.

That is, the small area background level information SL is adopted as background density reference information to be used for the process of eliminating background at each pixel of the image region extending from the position P1 to the position immediately before the position P2. The large area background level information LL# is adopted for the image region extending from the position P2 to the position immediately before the position P3. The small are background level information SL is adopted for the image regions beyond the position P3.

That is, the background elimination process is performed based on the large area background level information LL# in the part of the portrait 1151 of the normal original 1150 shown in FIG. 13A (the part of the image (portrait) as a result of the detection in the small areas shown in FIG. 13B).

As will be apparent from FIG. 19, when background density reference information 1150e is calculated for each unit of processing (small area) PU, there may be a density difference between two pieces of background density reference information relating to image regions adjacent to each other among a plurality of image regions extending in the main scanning direction (X-direction) corresponding to small areas as units of processing.

In the example shown in FIG. 19, there is a density difference between the two pieces of background density reference information relating to every pair of adjacent image regions. For example, there is a density difference ΔL between the two pieces of background density reference information relating to the image regions located between the position P2 and the position immediately before the position P3 or the two image regions adjacent to each other.

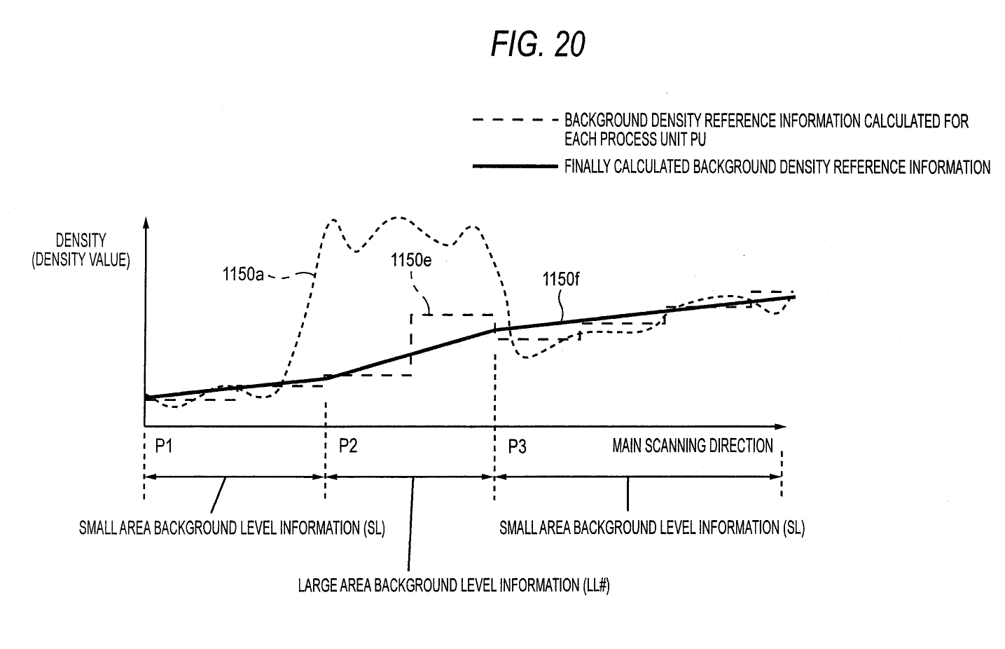

Then, the background density determination part 1522 adjusts the background density reference information 1150e such that “a smooth change in the background density reference information will occur” at each pixel. When the background density reference information is finally calculated (adjusted) as thus described, for example, background density reference information 1150f having characteristics as shown in FIG. 20 is obtained.

The background density determination part 1522 saves the final calculated background density reference information 1150f in the storage unit 143 and outputs it to the background elimination process portion 1530.

The background elimination process portion 1530 performs a background elimination process at each pixel based on the background density reference information 1150f from the background density determination part 1522.

When the background elimination process portion 1530 performs a background elimination process at each pixel based on the background density reference information 1150f (see FIG. 20), background associated with image data is more accurately eliminated when compared to the background elimination process performed at each pixel by the background elimination process portion 1530 based on the background density reference information 1150e (see FIG. 19).

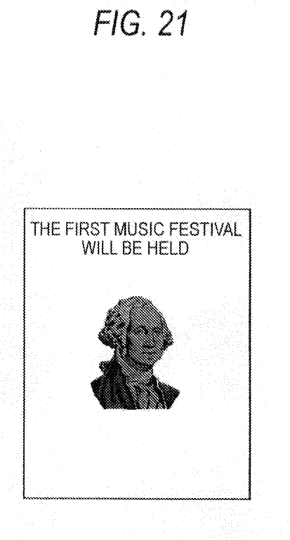

The image processing unit 150 performs a background detecting process and a background elimination process on a plurality of lines of the image data shown in FIG. 13A in the sub scanning direction (Y-direction) thereof in the same manner as for the line P. Then, an output image having no background is obtained as shown in FIG. 21 from the image data shown in FIG. 4 (image shown in FIG. 13A).

While the background density determination part 1522 of Embodiment 1 obtains the background density information 1150f (see FIG. 20) and outputs it to the background elimination process portion 1530, the background density reference information 1150e (see FIG. 19) determined for each small area as a unit of processing may alternatively be output to the background elimination process portion 1530.

When the background elimination process portion 1530 performs a background elimination process at each pixel based on the background density reference information 1150e, background associated with image data is more accurately eliminated when compared to the background elimination process performed at each pixel by the background elimination process portion 1530 based on the small area background level information 1150b (see FIG. 14) or the large area background level information 1150b adjusted by the background density adjusting part 1521 (see FIG. 18).

In Embodiment 1, the background density determination part 1522 determines background density reference information using the adjusted large area background level information 1150e obtained by the background density adjusting part 1521. Alternatively, the large area background level information 1530c detected by the large area background level detecting part 1512 (large area background level information which has not be adjusted by the background density adjusting part 1521) may be used as it is.

### Embodiment 2

An image processing device according to Embodiment 2 will now be described.

The image processing device of Embodiment 2 has the same functions and configuration as those of the image processing device 100 of Embodiment 1 shown in FIG. 1. Therefore, the device will not be described in detail.

Embodiment 2 is different from Embodiment 1 in that it makes it possible to perform both of a background elimination process on a normal original and a background elimination process on a combined image.

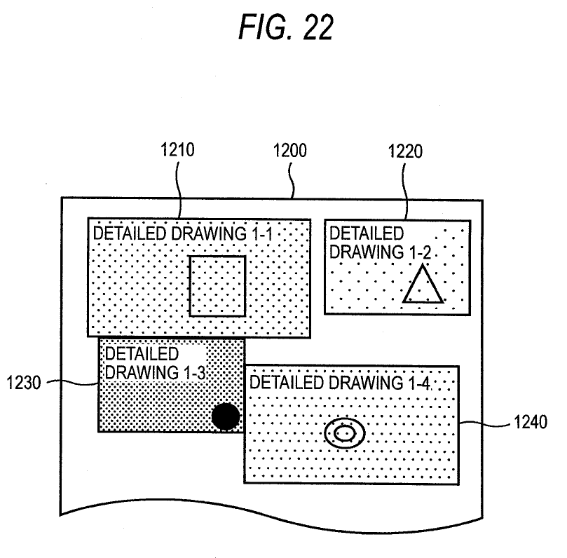

In the present specification, a combined original is an original that is, for example, a combination of a plurality of (four) images 1210 to 1240 as shown in FIG. 22.

The above-described difference of Embodiment 2 from Embodiment 1 will now be described in detail.

(A) Parameters in background elimination process are specified as follows.

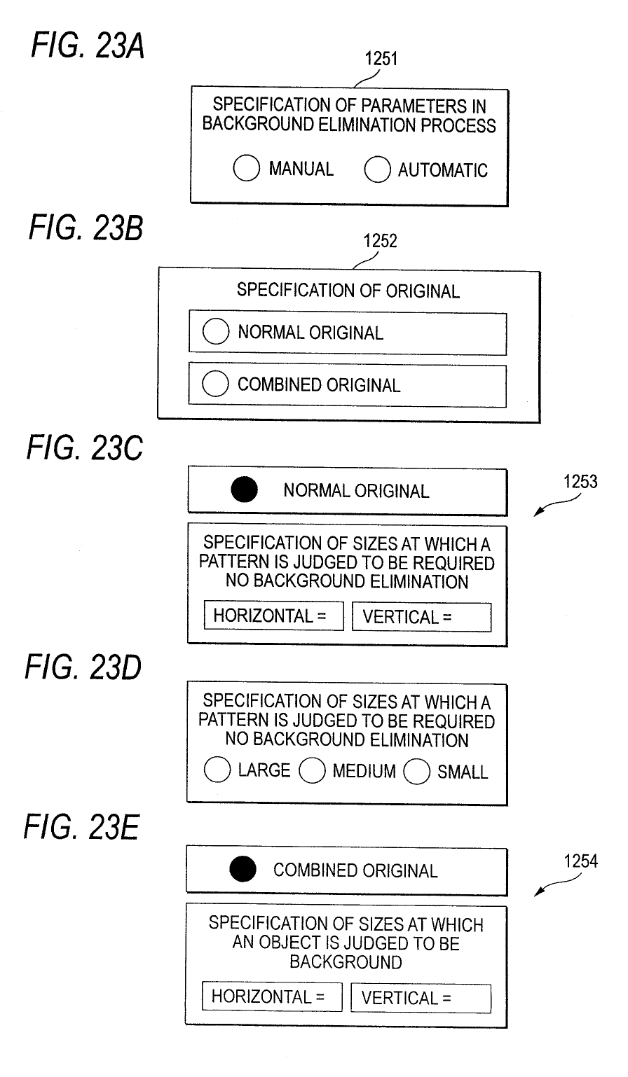

When a background elimination process function instruction key of an input key part 1130 is depressed by a user (see FIG. 2), display content 1251 is displayed on the display part 1110 (see FIG. 2) to accept the specification of a “parameter associated with the background elimination process”, as shown in FIG. 23A. Then, the user operates an operation panel portion 1100 to specify that the parameter will be manually input or that the parameter will be automatically input.

When it is specified that the parameter will be specified manually, as shown in FIG. 23B, display content 1252 is displayed on the display part 1110 to accept the specification of “the type of the original”. Then, the user operates the operation panel portion 1100 to specify “normal original” or “combined original”.

When it is specified that the original is a normal original, as shown in FIG. 23C, display content 1253 is displayed on the display part 1110 to accept the specification of “sizes at which a pattern is judged to be requiring no background elimination”. Then, the user operates the operation panel portion 1100 to specify a length (numerical value) in the horizontal direction and a length (numerical value) in the vertical direction.

Although it has been stated that sizes at which a pattern is judged to be requiring no background elimination are specified as “numerical values indicating horizontal and vertical sizes”, as shown in FIG. 23, desired items may alternatively be specified (selected) from among alternatives (items) “large”, “medium”, and “small” representing sizes.

When it is specified that the original is a combined original, as shown in FIG. 23E, display content 1254 is displayed on the display part 1110 to accept the specification of “sizes at which an object is judged to be background”. Then, the user operates the operation panel portion 1100 to specify a length (numerical value) in the horizontal direction and a length (numerical value) in the vertical direction.

It has been stated that sizes at which a pattern is judged to be requiring no background elimination are specified as “numerical values indicating horizontal and vertical sizes”. In this case again, desired items may alternatively be specified (selected) from among alternatives (items) “large”, “medium”, and “small” representing sizes in the same manner as the example shown in FIG. 23D.

(B) The size of a large area (second detection process unit) is determined as follows.

When “a normal original” is selected through an operation by a user on (the operation panel portion 1100) of the user input unit 110 (see FIG. 23B), the size of a large area (second detection process unit) is determined in the same manner as in Embodiment 1. When “a combine original” is selected (see FIG. 23B), the size of a large area (second detection process unit) may be a size which is determined in advance taking the size of the combined original into consideration or a size which is based on input information specified by a user through an input operation on the user input unit 110.

(C) A process as described below is performed by a background density determination part 1522 to determine background density reference information relating to image data to be processed at each unit of determination process (small area).

In Embodiment 2, the background density determination part 1522 performs processes as described in the following items (3-1) and (3-2) in addition to the processes as described in the items (2-1) and (2-2) which are associated with the process of determining background density reference information in Embodiment 1.

(3-1) When the process described in the item (2-1) is performed (see Embodiment 1), the value of a difference between small area background level information and adjusted large area background level information is equal to or greater than the threshold Δb, and small area background level information relating to a first image region associated with an image region on which the determination process is to be performed changes within a value of variation Δc in a preset range of image regions. Then, for each of plural first image regions included in the preset range of image regions, small area background level information relating to the first image region is determined as background density reference information.

(3-2) During the process described in the item (3-1), the value of a difference between the small area background level information relating to the first image region corresponding to the image region under the determination process and small area background level information relating to another first image region adjacent to the first image region satisfies the condition that it should be included in a predetermined range of allowable densities Δd and that the sum of plural first image regions corresponding to plural pieces of first background density detection information satisfying the condition exceeds the preset image regions. Then, for each of the plural first image regions included, small area background level information relating to the first image region is determined as background density reference information.

In Embodiment 2, when a background density determination part 1522 determines background density reference information, adjusted large area background level information obtained by a background density adjusting part 1521 is used. Alternatively, it is possible to use large area background level information which has not been adjusted by the background density adjusting part 1521 or large area background level information detected by a large area background level detecting part 1512 as it is.

However, in order to improve the accuracy of the background elimination process, it is preferable to obtain background density reference information using adjusted large area background level information obtained by the background density adjusting part 1521.

The processes of the items (3-1) and (3-2) will now be specifically described.

For example, the value of a difference (absolute value) between adjusted large area background level information LL1# relating to a large area image region LA1 and small area background level information “SL1-1” relating to a small area image region “SA1-1” is equal to or greater than a threshold Δb (a relationship “difference≧Δb” is true). Then, the background density determination part 1522 marks any small area image region whose difference from the small area background level information “SL1-1” relating to the small area image region “SA1-1” stays in a predetermined value of variation Δc among small area image regions “SA1-2”, “SA1-3”, and “SA1-4” which are horizontally, vertically, and diagonally adjacent to the small area image region “SA1-1”.

The value of variation Δc corresponds to the range of allowable densities Δd. When the value of a difference (absolute value) stays within the value of variation Δc, it means that the difference (absolute value) is within the range of allowable densities Δd.

Next, the background density determination part 1522 obtains differences (absolute values) in small area background level information between the small area image region thus marked and other small area image regions which are vertically, horizontally, and diagonally adjacent to the marked small area image region. Any of the other small area image regions having a difference (absolute value) within the value of variation Δc is marked.

When a plurality of small area image regions marked as described above exceed a preset range of image regions, for each of the plurality of small area image regions thus marked or the plurality of first image regions, the background density determination part 1522 determines the small area background level information relating to the relevant first image region as background density reference information.

For example, the preset range of image regions is six small area image regions in the X-direction in the example shown in FIG. 9 and that plural small area image regions “SA1-1”, “SA1-2”, “SA1-3”, “S1-4”, “SA2-1”, “SA2-2”, “SA2-3”, “SA2-4”, “SA 3-1-”, “SA3-2”, “SA3-3”, “SA3-4”, “SA4-1”, “SA4-2”, “SA4-3”, and “SA4-4” are marked. Then, since the plural (16) small area image regions exceed the six small area image regions in the X-direction, for each of the plural small area image regions, i.e., the plural first image regions, the small area background level information relating to the relevant first image region is determined to be background density reference information.

That is, when a relationship “the difference (absolute value)≦the value of variation Δc (or the range of allowable densities Δd” is true, for the plural (16) small area image regions, i.e., the plural first image regions, the respective pieces of small area background level information are adopted.

On the contrary, when a relationship “the difference (absolute value)>the value of variation Δc (or the range of allowable densities Δd” is true, for a small area image region or first image region associated with the image region under the determination process, large area background level information relating to the large image region associated with the second image region including the first image region is adopted. For example, when the small area image region associated with the image region under the determination process is the small area image region “SA1-1”, adjusted large area background level information LL1# relating to the large area image region LA1 is adopted for the small area image region “SA1-1”. For any other small area image region, adjusted large area background level information relating to the large area image region including the small area image region is similarly adopted.

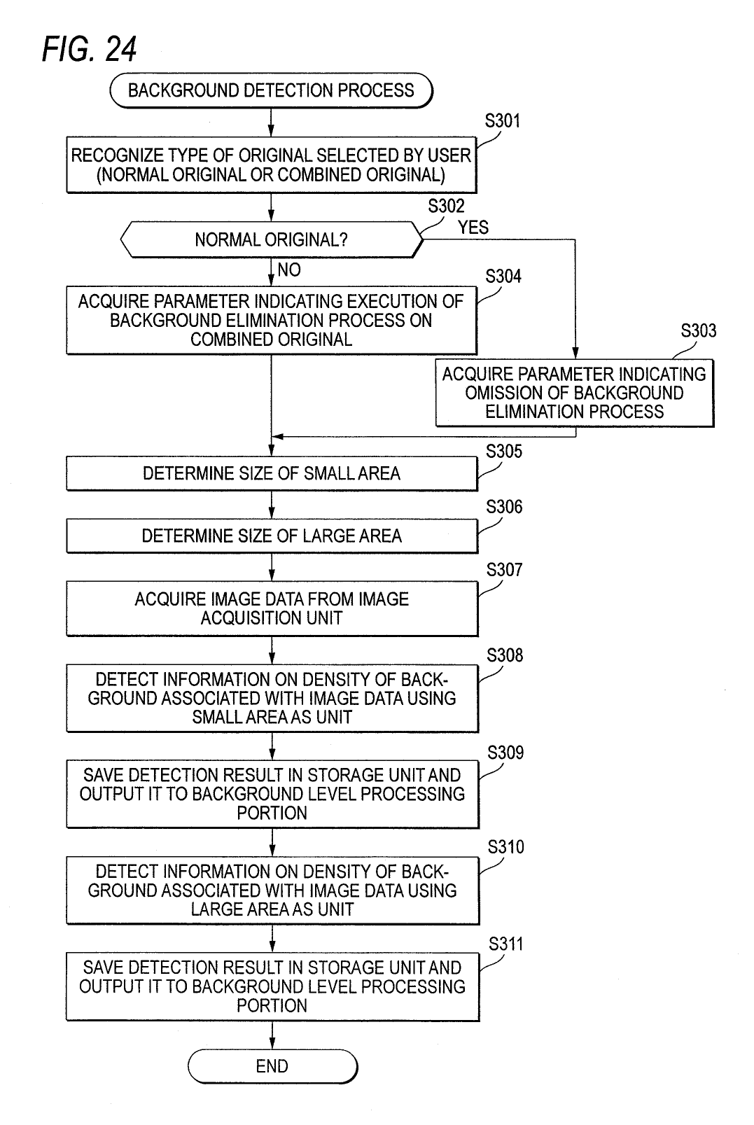

A background detecting process performed by an image processing unit 150 of the image processing device 100 will now be described with reference to FIG. 24.

A user operates (an operation panel portion 1110) of a user input unit 110 to specify parameters in background elimination process. Specifically, the user operates the operation panel portion 1110 to first specify “manual” concerning parameter specification as in the example shown in FIG. 23A. Then, the user specifies “normal original” or “combined original” as in the example shown in FIG. 23C. The user then specifies a size according to the specified type of original as in the example shown in FIG. 23C or 23E.

As a result, in the example shown in FIG. 23C or 23E, information indicating the specified size, i.e., “information indicating sizes at which a pattern is judged to be requiring no background elimination” associated with “normal original” or “information indicating a size at which an object is judged to be background” associated with “combined original” is saved in a parameter storage unit 120.

For example, when “automatic” is specified in association with parameter specification in the example shown in FIG. 23A, parameters in the background elimination process which are stored in the parameter storage unit 120 as defaults will be used.

A background level detecting portion 1510 of the image processing unit 150 reads the information indicating the original type from the parameter storage unit 120 to recognize the original type selected by the user (step S301) and determines whether the selected original is a normal original or not (step S302).

When it is determined that the original is a normal original at step S302, the background level detecting portion 1510 obtains parameters in the background elimination process from the parameter storage unit 120. That is, it reads “size” parameters in the omission of the background elimination process (information indicating sizes at which a pattern is judged to be requiring no background elimination” (step S303).

On the contrary, when it is determined that the original is a combined original at step S302, the background level detecting portion 1510 obtains parameters in the background elimination process from the parameter storage unit 120. That is, it reads “size” parameters in the execution of the background elimination process (information indicating sizes at which an object is judged to be background (step S304).

When step S303 or S304 is completed, the process proceeds following processing steps similar to steps S120 to S180 of the processing procedure of Embodiment 1 shown in FIG. 12 (steps S305 to S311).

At steps S305 and S306, the size of a small area as a first detection process unit and the size of a large area as a second detection process unit are determined based on the “size” parameters in the omission of the background elimination process obtained at step S303 or the “size” parameters in the execution of the background elimination process obtained at step S303.

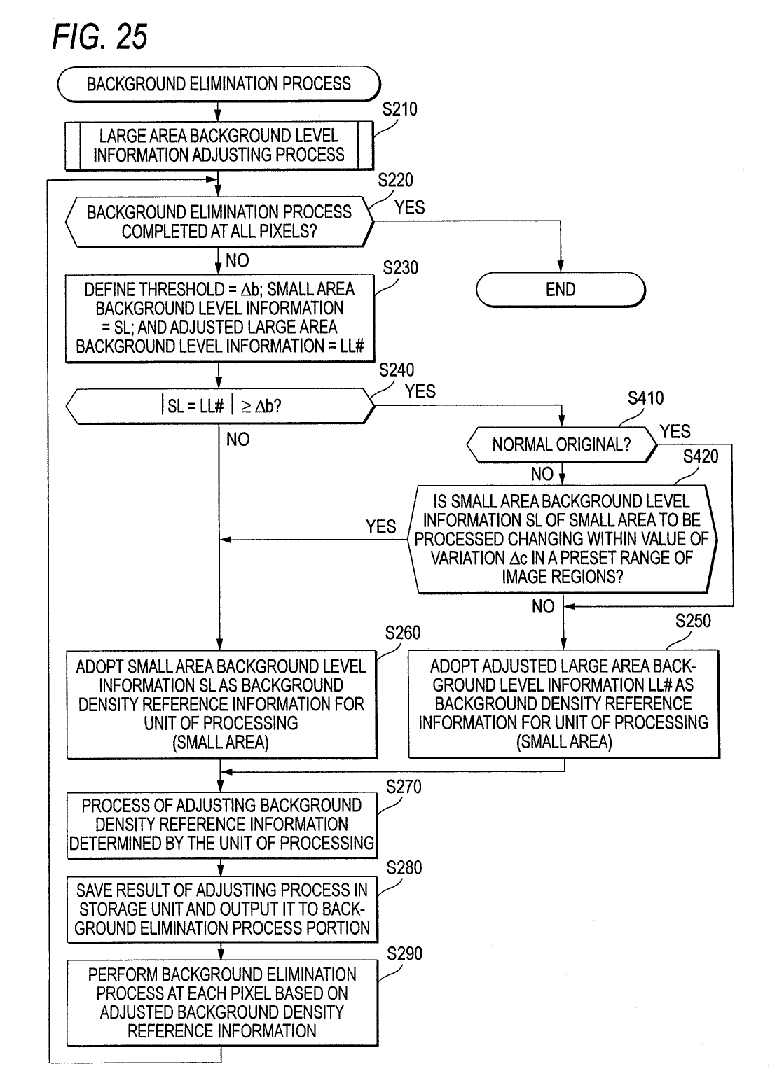

The background elimination process performed by the image processing unit 150 of the image processing device 100 will now be described with reference to FIG. 25.

FIG. 25 is a flow chart showing processing steps of the background elimination process.

The processing steps shown in FIG. 25 are similar to the processing steps of the background elimination process in Embodiment 1 shown in FIG. 16 except that steps S410 and S420 are added between the positive judgment “YES” at step S240 and step S250.

Specifically, when is determined at step S240 in FIG. 25 that the absolute value of a difference between small area background level information SL and large area background level information LL# (|SL−LL#1|) is equal to or greater than the threshold Δb (when a relationship “|SL-LL#1|≧Δb” is true), a background density determination part 1522 determines whether the object of the process is a normal original or not (step S410).

When it is determined that the object is a normal original at step S410, the background density determination part 1522 proceeds to step S250. When it is determined that the object is not a normal original (it is determined that the object is a combined original), determination part determines whether small area background level information SL relating to a first image region corresponding to the image region under the determination process is changing within the value of variation Δc or whether the relational expression “the difference (absolute value)≧the value of variation Δc (or the range of allowable densities Δd)” is true or not (step 5420) in a preset range of image regions.

When it is determined at step S420 that the relational expression is true, the background density determination part 1522 proceeds to step S260. When it is determined that the relational expression is not true (“the difference (absolute value)>the value of variation Δc (or the range of allowable densities Δd)”, the process proceeds to step S250.

That is, when the object of the process is image data of a normal original, the process branches to either the execution of step S260 through “NO” at step S240 or the execution of step S250 through “YES” at steps S240 and S410.

A background elimination process portion 1530 performs the background elimination process at each pixel of the image data of a normal original based on background density reference information which has been finally calculated.

When the image processing unit 150 performs the above-described background detecting process and background elimination process on plural lines extending in the sub scanning direction (Y-direction) of the image data of a normal original, an output image having no background as shown in FIG. 21 can be obtained in association with, for example, the image data shown in FIG. 4 (the image shown in FIG. 13A) in the same manner as in Embodiment 1.

On the contrary, when the object of the process is image data of a combined original, the process branches to any of the execution of step S260 through “NO” at step S240, the execution of step S260 through “NO” at step S240 and “YES” at step S410, and the execution of step S250 through “NO” at step S240 and “NO” at step S410.

The background elimination process portion 1530 performs the background elimination process at each pixel of the image data of a combined original based on background density reference information which has been finally calculated.

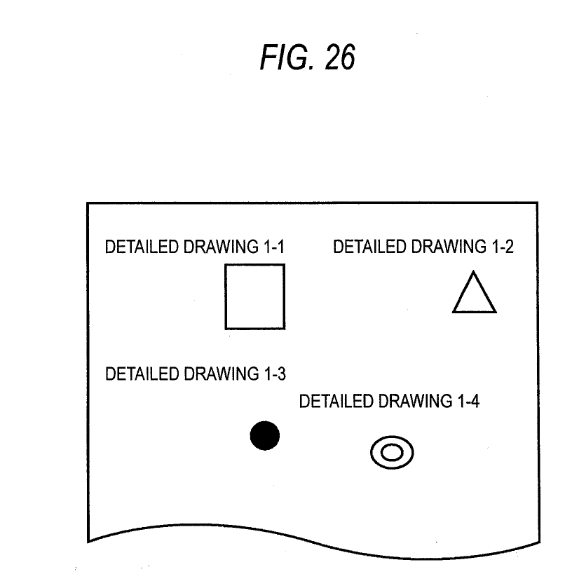

When the image processing unit 150 performs the above-described background detecting process and background elimination process on plural lines extending in the sub scanning direction (Y-direction) of the image data of a combined original, an output image having no background as shown in FIG. 26 can be obtained in association with, for example, the image data (image) shown in FIG. 22.

While a small area and a large area have been described as square regions having the same length (the same number of pixels) in the X- and Y-directions in this specification, they may be rectangular regions having different lengths (different numbers of pixels) in the X- and Y-directions. Although it has been described that a small area and a large area are formed adjacent to each other without any overlap, they may be formed as areas having such ranges that some of their pixels overlap each other in the vertical or horizontal direction. Further, although those areas have been described as having a square shape, they may have any shape other than a square shape such as a polygonal, circular or elliptic shape as long as they occupy some area.

The plural detection process units in this specification has been described as a first detection process unit (small area) and a second detection process unit (large area), three or more units of detection process having different sizes may alternatively be used. In this case, an optimum background level (background density reference information) may be determined using any of plural pieces of background level information (pieces of background level information relating to plural image regions corresponding to plural detection process units) may be adopted as reliable background level information as described above. Alternatively, an optimum background level may be calculated from an average value or an intermediate value of plural pieces of background level information or calculated using a weighting factor such as a maximum frequency or precedence of the pieces of information.

Further, although it has been described that the first detection process unit or the small area constitutes a unit of determination process in this specification, the unit of determination process may be an area having an arbitrary size.

In the present specification, an information processing apparatus is constituted by a CPU, a memory, and storage devices like the printer or image processing device (see FIG. 10) described in Embodiment 1.

Further, this specification has addressed embodiments in which predetermined programs including a program for realizing the functions of the image processing device and indicating the processing steps of the image processing and a program for realizing the functions of a decomposer and a simulating unit in storage devices such as a hard disk as storage media. However, such predetermined programs may be provided as described below.

The above-described predetermined programs mat be stored in a ROM in advance, and a CPU may load the programs from the ROM into a main storage unit to execute them.

The above-described predetermined programs may be distributed by storing them in a computer-readable recording medium such as a DVD-ROM, CD-ROM, MO (magneto-optical) disk, or flexible disk. In this case, the programs recorded in the recording medium are performed by a CPU after they are installed by the image processing device. The programs may be installed in a memory such as a ROM or a storage device such as a hard disk. The image processing device may load the programs recorded in the storage device into a main storage to execute them as occasions demand.

Further, the image processing device may be connected to a server apparatus or a computer such as a host computer through a telecommunication network (e.g., internet). Then, the image processing device may execute the predetermined programs after downloading them from the server apparatus or computer. In this case, the programs may be downloaded to a memory such as a RAM or storage device (recording medium) such as a hard disk. Then, the image processing device may execute the programs stored in the storage device by loading them into a main storage as occasions demand.

The invention may be applied to an image processing device for providing image data to be printed to an image forming apparatus such as a printing apparatus for printing images or an image forming apparatus having a plurality of image forming functions including at least a printing function. The invention may be also applied to an image forming apparatus including such an image processing device and an image forming system including such an image forming apparatus.

What is claimed is:

1. An image processing device comprising:
an image acquisition section that acquires image information; and
an image processing section that obtains a plurality pieces of density information on background of the image information for different detection process units in detection process of background density of the image information, and eliminates the background from the image information based on the plurality of pieces of density information for the detection process units.

2. The image processing device according to claim 1, wherein the image processing section obtains reference information on eliminating of the background of the image information, based on the plurality of pieces of density information for the detection process units, and eliminates the background at each pixel of the image information.

3. The image processing device according to claim 1, wherein the image processing section includes:
a plurality of density detecting sections that detect the density information of the background of the image information in each of the detection process units corresponding to image regions of different sizes;
a density processing section that obtains the reference information on eliminating of the background of the image information, based on the plurality of pieces of density information; and
an background eliminating section that eliminates the background from the image information based on the reference.

4. The image processing device according to claim 3, wherein the plurality of density detecting sections include:
a first density detecting section that detects a first density information on the background of the image information in a first detection process unit corresponding a first image region; and
a second density detecting section that detects a second density information on the background of the image information in a second detection process unit corresponding to a second image region, the second image region encompassing the first image region.

5. The image processing device according to claim 4, wherein
the density processing section includes a density determination section, and
when a threshold is equal to or exceeded by a difference value between the first density information of the first image region corresponding to an image region to be processed and the second density information of the second image region encompassing the first region, the density determination section determines the second density information as the reference information for the image region to be processed.

6. The image processing device according to claim 5, wherein when the difference values between the first density information and the second density information is smaller than the threshold, the density determination section determines the first density information as the reference information for the image region to be processed.

7. The image processing device according to claim 5, wherein when the difference value between the first density information and the second density information is equal to or greater than the threshold and when the first density information relating to a plurality of first image regions encompassed in a preset range of image regions changes within a value of variation, the density determination section determines the first density information as the reference information for each of the first image regions.

8. The image processing device according to claim 7, wherein when a difference value between the first density information relating to the first image region in the image region to be processed and the first density information relating to a first image region adjacent thereto satisfies a condition that the difference value is within a range of allowable densities and when a sum of a plurality of first image regions associated with a plurality of pieces of first density information satisfying the condition exceeds the preset range of image regions, the density determination section determines the first density information as the reference information for each of the plurality of first image regions.

9. The image processing device according to claim 5, wherein
the density processing section includes a density adjusting section that adjusts the second density information on a second image region according to a condition; and
the density determination section determines the reference information for the first image region to be processed, based on the adjusted second density information and the first density information.

10. The image processing device according to claim 9, wherein when a threshold is equal to or exceeded by a difference value between the second density information of the second image region of interest corresponding to the second detection process unit and an average value of the first density information relating to the second image region of interest, the density adjusting section adjusts the second density information of a second image region of interest, based on the second density information of a second image region in the vicinity of the second image region of interest.

11. The image processing device according to claim 10, wherein the density adjusting section adopts an average value of the second density information of second image regions in the vicinity of the second image region of interest as the second density information of the second image region of interest.

12. The image processing device according to claim 10, wherein the density adjusting section adopts the second density information, which is smallest in value of difference from the second density information of the second image region of interest, among pieces of second density information of second image regions in the vicinity of the second image region of interest.

13. The image processing device according to claim 9, wherein the density adjusting section adopts the second density information of the second image region of interest when a difference values between the second density information of the second image region of interest and an average value of the first density information of the second image region of interest is smaller than a threshold.

14. An image forming apparatus comprising an image processing device according to claim 1 that forms apparatus performing a process of eliminating background of image information, the image forming apparatus performing an image forming process based on the image information on which the process of eliminating background is completed.

15. An image forming system comprising:
an image forming apparatus according to claim 14;
a processor for transmitting image information to the image forming apparatus; and
a communication network connecting the image forming apparatus and the processor,
the image forming apparatus performing a process of eliminating background of the image information obtained through the communication network and performing an image forming process based on the image information on which the process of eliminating background is completed.

16. An image processing method comprising:
obtaining a plurality pieces of density information on background of image information for different detection process units in detection process of background density of the image information; and
eliminating the background from the image data based on the plurality of pieces of density information for the detection process units.

17. A computer readable medium storing a program causing a computer to execute image processing, the image processing comprising:
obtaining a plurality pieces of density information on background of image Information for different detection process units in detection process of background density of the image information; and
eliminating the background from the image data based on the plurality of pieces of density information for the detection process units.
